(19) United States
(12) Patent Application Publication
(10) Pub. No.: US 2003/0026515 A1
(43) Pub. Date: Feb. 6, 2003

(54) Monolithic tunable wavelength multiplexers and demultiplexers and methods for fabricating same

(75) Inventors: Barbara Foley Barenburg, Gilbert, AZ (US); Joyce Yamamoto, Chandler, AZ (US)

Correspondence Address: OBLON SPIVAK MCCLELLAND MAIER & NEUSTADT PC, FOURTH FLOOR, 1755 JEFFERSON DAVIS HIGHWAY, ARLINGTON, VA, 22202, US

(73) Assignee: MOTOROLA, INC., Schaumburg, IL

(21) Appl. No.: 09/918,802

(22) Filed: Aug. 1, 2001

(51) Int. Cl. G02B 6/10; G02B 6/12; G02B 6/13; G02B 6/293

(52) U.S. Cl. 385/14; 385/24; 385/131

(57) ABSTRACT

The present invention provides a wavelength-tunable optical device structure which monolithically integrates both active and passive device components on a single substrate. Monolithically-integrated active and passive optical device components may be fabricated by growing high-quality active optical devices, such as optical emitters and optical detectors, on a single substrate and using electro-optical crystalline oxide materials to tune optical devices, such as directional couplers, to transmit radiation having selected wavelengths. In this manner, cost-effective, monolithically-integrated, tunable wavelength multiplexers and/or demultiplexers may be formed.

### FIELD OF THE INVENTION

This invention relates generally to optoelectronic semiconductor structures and devices and, more particularly, to tunable wavelength multiplexer and demultiplexer device structures and methods for fabricating such structures.

### BACKGROUND OF THE INVENTION

Integrated optical circuits (IOCs) are thin-film circuits which integrate active components, such as laser diodes and photodiodes, with functionally passive components, such as waveguides, on a single semiconductor substrate. IOCs are useful in a variety of applications, including telecommunications, medicine, material diagnostics, spectroscopy, isotope separation, and remote sensing. One particular category of IOCs includes wavelength multiplexers and demultiplexers, which are important components for fabricating transmitter and receiver terminals for Wavelength Division Multiplexing (WDM) optical communications systems. WDM is a fiber-optic transmission and reception process which combines and simultaneously transmits (or receives) multiple optical carrier signals of distinct wavelengths through a single optical fiber. Such systems and processes enable the transmission and reception of large volumes of data. Wavelength-tunable WDM systems offer the potential for substantially increasing the speed and transmission capacity of multi-wavelength optical networks and are, therefore, in great demand.

The great majority of IOCs are fabricated on silicon substrates, at least in part because of the availability of inexpensive, high-quality monocrystalline silicon substrates. Other semiconductor materials, such as the so-called compound semiconductor materials, have physical attributes, including wider bandgap and/or higher mobility than silicon, or direct bandgaps that make these materials advantageous for IOC devices. Unfortunately, compound semiconductor materials are generally much more expensive than silicon and are not available in large wafers as is silicon. Gallium arsenide (GaAs), the most readily available compound semiconductor material, is available in wafers only up to about 150 millimeters (mm) in diameter. By contrast, silicon wafers are available in diameters up to about 300 mm and are widely available at 200 mm. The 150 mm GaAs wafers are many times more expensive than are their silicon counterparts. Wafers of other compound semiconductor materials are even less available and are more expensive than GaAs.

For many years, attempts have been made to grow various monolithic thin-films on a foreign substrate such as silicon (Si). These attempts generally have been unsuccessful because crystal lattice mismatches between the host crystal and the grown crystal have produced monocrystalline material layers of low crystalline quality. Since high crystalline quality thin-films yield monolithic layers having optimal characteristics, structures and fabrication processes which enable the monolithic integration of various thin-films on a foreign substrate are highly desirable. Thus, if a large-area thin film of high-quality monocrystalline material were available at low cost, a variety of IOCs could be advantageously fabricated either in or on that film relatively inexpensively, when compared to the cost of fabricating such devices either directly on a bulk wafer of semiconductor material or in an epitaxial film of such material on a bulk wafer of semiconductor material. In addition, if a thin-film of high-quality monocrystalline material could be achieved on a bulk wafer, such as a silicon wafer, a monolithically-integrated optical device structure could be fabricated which benefited from the best properties of both the silicon substrate and the high-quality monocrystalline material.

Accordingly, there is a need for a wavelength-tunable optical device structure which monolithically integrates both active and passive device components on a single substrate. There is also a need for a method of fabricating monolithically-integrated active and passive device components to thereby provide cost-effective, highly tunable optical integrated circuits. Additionally, there is a need for an optical device structure which includes monolithically-integrated, wavelength-tunable multiplexers and/or demultiplexers.

### BRIEF DESCRIPTION OF THE DRAWINGS

The present invention is illustrated by way of example, and not of limitation, in the accompanying figures, in which like references indicate similar elements, and in which:

FIGS. 1, 2, and 3 illustrate schematically, in cross section, device structures in accordance with various embodiments of the invention;

FIG. 4 graphically illustrates maximum attainable film thickness for a high-quality grown crystal layer as a function of the degree of lattice mismatch between a host crystalline material and the grown crystalline material;

FIG. 5 illustrates a high resolution Transmission Electron Micrograph of a structure including a monocrystalline accommodating buffer layer;

FIG. 6 illustrates an x-ray diffraction spectrum of a structure including a monocrystalline accommodating buffer layer;

FIG. 7 illustrates a high resolution Transmission Electron Micrograph of a structure including an amorphous oxide layer;

FIG. 8 illustrates an x-ray diffraction spectrum of a structure including an amorphous oxide layer;

FIG. 9 schematically illustrates a Wavelength Division Multiplexing system;

FIG. 10 schematically illustrates a top plan view of an exemplary multiplexer system in accordance with an embodiment of the present invention;

FIG. 11 illustrates a cross-sectional view of the exemplary multiplexer system of FIG. 10;

FIG. 12 illustrates a cross-sectional view of a radiation receiver in accordance with an embodiment of the invention;

FIG. 13 illustrates a cross-sectional view of a stacked waveguide structure in accordance with an embodiment of the invention;

FIG. 14 illustrates a cross-sectional view of a planar waveguide structure in accordance with another embodiment of the invention;

FIG. 15 illustrates a cross-sectional view of a planar waveguide structure in accordance with yet another embodiment of the invention;

FIG. 16 illustrates a cross-sectional view of a stacked waveguide structure in accordance with a further embodiment of the invention;

FIG. 17 schematically illustrates a top plan view of an exemplary demultiplexer system in accordance with an embodiment of the present invention;

FIG. 18 illustrates a cross-sectional view of the exemplary demultiplexer system of FIG. 17;

FIG. 19 illustrates a cross-sectional view of a radiation source in accordance with an embodiment of the invention;

FIG. 20 schematically illustrates a top plan view of an exemplary configuration of a portion of a demultiplexer system in accordance with an embodiment of the invention;

FIG. 21 schematically illustrates a top plan view of another exemplary embodiment of a demultiplexer system in accordance with the present invention;

FIG. 22 illustrates a cross-sectional view of the exemplary demultiplexer system of FIG. 20;

FIG. 23 schematically illustrates another exemplary demultiplexer system in accordance with an embodiment of the present invention.

Skilled artisans will appreciate that the elements in the figures are illustrated for simplicity and clarity and have not necessarily been drawn to scale. For example, the dimensions of some of the elements in the figures may be exaggerated relative to other elements to enhance understanding of the various embodiments of the present invention.

### DETAILED DESCRIPTION OF THE INVENTION

The following disclosure presents and describes various exemplary embodiments in sufficient detail to enable those skilled in the art to practice the invention, and it should be understood that other embodiments may be realized without departing from the spirit and the scope of the invention. Thus, the following detailed description is presented for purposes of illustration only, and not of limitation, and the scope of the invention is defined solely by the appended claims.

FIG. 1 illustrates schematically, in cross-section, a portion of a semiconductor structure 20 in accordance with an embodiment of the invention. Semiconductor structure 20 includes a monocrystalline substrate 22, accommodating buffer layer 24 comprising a monocrystalline material, and a monocrystalline material layer 26. In this context, the term “monocrystalline” shall have the meaning commonly used within the semiconductor industry. The term shall refer to materials that are a single crystal or that are substantially a single crystal and shall include those materials having a relatively small number of defects such as dislocations and the like as are commonly found in substrates of silicon or germanium or mixtures of silicon and germanium and epitaxial layers of such materials commonly found in the semiconductor industry.

In accordance with one embodiment of the invention, structure 20 also includes an amorphous intermediate layer 28 positioned between substrate 22 and accommodating buffer layer 24. Structure 20 may also include a template layer 30 between the accommodating buffer layer and monocrystalline material layer 26. As will be explained more fully below, the template layer helps to initiate the growth of the monocrystalline material layer on the accommodating buffer layer. The amorphous intermediate layer helps to relieve the strain in the accommodating buffer layer and by doing so, aids in the growth of a high crystalline quality accommodating buffer layer.

Substrate 22, in accordance with an embodiment of the invention, is a monocrystalline semiconductor or compound semiconductor wafer, preferably of large diameter. The wafer can be of, for example, a material from Group IV of the periodic table. Examples of Group IV semiconductor materials include silicon, germanium, mixed silicon and germanium, mixed silicon and carbon, mixed silicon, germanium and carbon, and the like. Preferably substrate 22 is a wafer containing silicon or germanium, and most preferably is a high quality monocrystalline silicon wafer as used in the semiconductor industry. Accommodating buffer layer 24 is preferably a monocrystalline oxide or nitride material epitaxially grown on the underlying substrate. In accordance with one embodiment of the invention, amorphous intermediate layer 28 is grown on substrate 22 at the interface between substrate 22 and the growing accommodating buffer layer by the oxidation of substrate 22 during the growth of layer 24. The amorphous intermediate layer serves to relieve strain that might otherwise occur in the monocrystalline accommodating buffer layer as a result of differences in the lattice constants of the substrate and the buffer layer. As used herein, lattice constant refers to the distance between atoms of a cell measured in the plane of the surface. If such strain is not relieved by the amorphous intermediate layer, the strain may cause defects in the crystalline structure of the accommodating buffer layer. Defects in the crystalline structure of the accommodating buffer layer, in turn, would make it difficult to achieve a high quality crystalline structure in monocrystalline material layer 26 which may comprise a semiconductor material, a compound semiconductor material, or another type of material such as a metal or a non-metal.

Accommodating buffer layer 24 is preferably a monocrystalline oxide or nitride material selected for its crystalline compatibility with the underlying substrate and with the overlying material layer. For example, the material could be an oxide or nitride having a lattice structure closely matched to the substrate and to the subsequently applied monocrystalline material layer. Materials that are suitable for the accommodating buffer layer include metal oxides such as the alkaline earth metal titanates, alkaline earth metal zirconates, alkaline earth metal hafnates, alkaline earth metal tantalates, alkaline earth metal ruthenates, alkaline earth metal niobates, alkaline earth metal vanadates, alkaline earth metal tin-based perovskites, lanthanum aluminate, lanthanum scandium oxide, and gadolinium oxide. Additionally, various nitrides such as gallium nitride, aluminum nitride, and boron nitride may also be used for the accommodating buffer layer. Most of these materials are insulators, although strontium ruthenate, for example, is a conductor. Generally, these materials are metal oxides or metal nitrides, and more particularly, these metal oxide or nitrides typically include at least two different metallic elements. In some specific applications, the metal oxides or nitrides may include three or more different metallic elements.

Amorphous interface layer 28 is preferably an oxide formed by the oxidation of the surface of substrate 22, and more preferably is composed of a silicon oxide. The thickness of layer 28 is sufficient to relieve strain attributed to mismatches between the lattice constants of substrate 22 and accommodating buffer layer 24. Typically, layer 28 has a thickness in the range of approximately 0.5-5 nm.

The material for monocrystalline material layer 26 can be selected, as desired, for a particular structure or application. For example, the monocrystalline material of layer 26 may comprise a compound semiconductor which can be selected, as needed for a particular semiconductor structure, from any of the Group IIIA and VA elements (III-V semiconductor compounds), mixed III-V compounds, Group II(A or B) and VIA elements (II-VI semiconductor compounds), and mixed II-VI compounds. Examples include gallium arsenide (GaAs), gallium indium arsenide (GaInAs), gallium aluminum arsenide (GaAlAs), indium phosphide (InP), cadmium sulfide (CdS), cadmium mercury telluride (CdHgTe), zinc selenide (ZnSe), zinc sulfur selenide (ZnSSe), and the like. However, monocrystalline material layer 26 may also comprise other semiconductor materials, metals, or non-metal materials which are used in the formation of semiconductor structures, devices and/or integrated circuits.

Appropriate materials for template 30 are discussed below. Suitable template materials chemically bond to the surface of the accommodating buffer layer 24 at selected sites and provide sites for the nucleation of the epitaxial growth of monocrystalline material layer 26. When used, template layer 30 has a thickness ranging from about 1 to about 10 monolayers.

FIG. 2 illustrates, in cross section, a portion of a semiconductor structure 40 in accordance with a further embodiment of the invention. Structure 40 is similar to the previously described semiconductor structure 20, except that an additional buffer layer 32 is positioned between accommodating buffer layer 24 and monocrystalline material layer 26. Specifically, the additional buffer layer is positioned between template layer 30 and the overlying layer of monocrystalline material. The additional buffer layer, formed of a semiconductor or compound semiconductor material when the monocrystalline material layer 26 comprises a semiconductor or compound semiconductor material, serves to provide a lattice compensation when the lattice constant of the accommodating buffer layer cannot be adequately matched to the overlying monocrystalline semiconductor or compound semiconductor material layer.

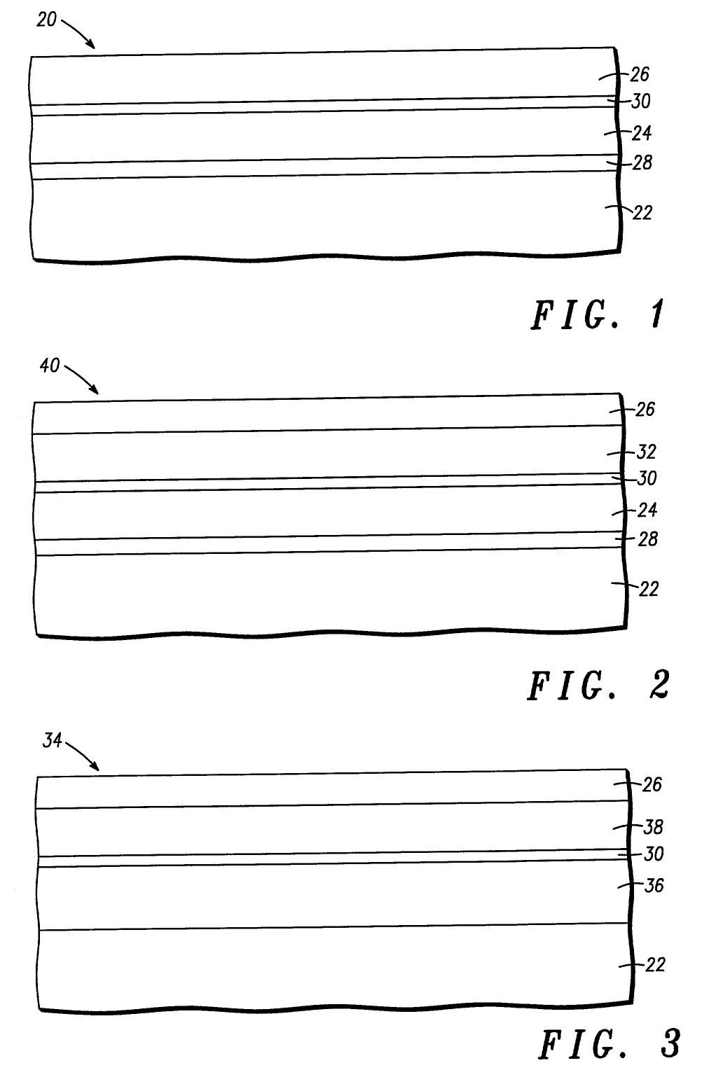

FIG. 3 schematically illustrates, in cross section, a portion of a semiconductor structure 34 in accordance with another exemplary embodiment of the invention. Structure 34 is similar to structure 20, except that structure 34 includes an amorphous layer 36, rather than accommodating buffer layer 24 and amorphous interface layer 28, and an additional monocrystalline layer 38.

As explained in greater detail below, amorphous layer 36 may be formed by first forming an accommodating buffer layer and an amorphous interface layer in a similar manner to that described above. Monocrystalline layer 38 is then formed (by epitaxial growth) overlying the monocrystalline accommodating buffer layer. The accommodating buffer layer is then exposed to an anneal process to convert the monocrystalline accommodating buffer layer to an amorphous layer. Amorphous layer 36 formed in this manner comprises materials from both the accommodating buffer and interface layers, which amorphous layers may or may not amalgamate. Thus, layer 36 may comprise one or two amorphous layers. Formation of amorphous layer 36 between substrate 22 and additional monocrystalline layer 26 (subsequent to layer 38 formation) relieves stresses between layers 22 and 38 and provides a true compliant substrate for subsequent processing (e.g., monocrystalline material layer 26 formation).

The processes previously described above in connection with FIGS. 1 and 2 are adequate for growing monocrystalline material layers over a monocrystalline substrate. However, the process described in connection with FIG. 3, which includes transforming a monocrystalline accommodating buffer layer to an amorphous oxide layer, may be better for growing monocrystalline material layers because it allows any strain in layer 26 to relax.

Additional monocrystalline layer 38 may include any of the materials described throughout this application in connection with either of monocrystalline material layer 26 or additional buffer layer 32. For example, when monocrystalline material layer 26 comprises a semiconductor or compound semiconductor material, layer 38 may include monocrystalline Group IV or monocrystalline compound semiconductor materials.

In accordance with one embodiment of the present invention, additional monocrystalline layer 38 serves as an anneal cap during layer 36 formation and as a template for subsequent monocrystalline layer 26 formation. Accordingly, layer 38 is preferably thick enough to provide a suitable template for layer 26 growth (at least one monolayer) and thin enough to allow layer 38 to form as a substantially defect free monocrystalline material.

In accordance with another embodiment of the invention, additional monocrystalline layer 38 comprises monocrystalline material (e.g., a material discussed above in connection with monocrystalline layer 26) that is thick enough to form devices within layer 38. In this case, a semiconductor structure in accordance with the present invention does not include monocrystalline material layer 26. In other words, the semiconductor structure in accordance with this embodiment only includes one monocrystalline layer disposed above amorphous oxide layer 36.

The following non-limiting, illustrative examples illustrate various combinations of materials useful in structures 20, 40, and 34 in accordance with various alternative embodiments of the invention. These examples are merely illustrative, and it is not intended that the invention be limited to these illustrative examples.

### EXAMPLE 1

In accordance with one embodiment of the invention, monocrystalline substrate 22 is a silicon substrate oriented in the <100> direction. The silicon substrate can be, for example, a silicon substrate as is commonly used in making complementary metal oxide semiconductor (CMOS) integrated circuits having a diameter of about 200-300 mm. In accordance with this embodiment of the invention, accommodating buffer layer 24 is a monocrystalline layer of Sr_{z}Ba_{1-z}TiO₃ (where z ranges from 0 to 1) and the amorphous intermediate layer is a layer of silicon oxide (SiOx) formed at the interface between the silicon substrate and the accommodating buffer layer. The value of z is selected to obtain one or more lattice constants closely matched to corresponding lattice constants of the subsequently formed layer 26. The accommodating buffer layer can have a thickness of about 2 to about 100 nanometers (nm) and preferably has a thickness of about 5 nm. In general, it is desired to have an accommodating buffer layer thick enough to isolate the monocrystalline material layer 26 from the substrate to obtain the desired electrical and optical properties. Layers thicker than 100 nm usually provide little additional benefit while increasing cost unnecessarily; however, thicker layers may be fabricated if needed. The amorphous intermediate layer of silicon oxide can have a thickness of about 0.5-5 nm, and preferably a thickness of about 1 to 2 nm.

In accordance with this embodiment of the invention, monocrystalline material layer 26 is a compound semiconductor layer of gallium arsenide (GaAs) or aluminum gallium arsenide (AlGaAs) having a thickness of about 1 nm to about 100 micrometers (nm) and preferably a thickness of about 0.5 μm to 10 μm. The thickness generally depends on the application for which the layer is being prepared. To facilitate the epitaxial growth of the gallium arsenide or aluminum gallium arsenide on the monocrystalline oxide, a template layer is formed by capping the oxide layer. The template layer is preferably 1-10 monolayers of Ti—As, Sr—O—As, Sr—Ga—O, or Sr—Al—O. By way of a preferred example, 1-2 monolayers of Ti—As or Sr—Ga—O have been illustrated to successfully grow GaAs layers.

### EXAMPLE 2

In accordance with a further embodiment of the invention, monocrystalline substrate 22 is a silicon substrate as described above. The accommodating buffer layer is a monocrystalline oxide of strontium or barium zirconate or hafnate in a cubic or orthorhombic phase with an amorphous intermediate layer of silicon oxide formed at the interface between the silicon substrate and the accommodating buffer layer. The accommodating buffer layer can have a thickness of about 2-100 nm and preferably has a thickness of at least 5 nm to ensure adequate crystalline and surface quality and is formed of a monocrystalline SrZrO₃, BaZrO₃, SrHfO₃, BaSnO₃ or BaHfO₃. For example, a monocrystalline oxide layer of BaZrO₃ can grow at a temperature of about 700° C. The lattice structure of the resulting crystalline oxide exhibits a 45° rotation with respect to the substrate silicon lattice structure.

An accommodating buffer layer formed of these zirconate or hafnate materials is suitable for the growth of a monocrystalline material layer which comprises compound semiconductor materials in the indium phosphide (InP) system. In this system, the compound semiconductor material can be, for example, indium phosphide (InP), indium gallium arsenide (InGaAs), aluminum indium arsenide, (AlInAs), or aluminum gallium indium arsenic phosphide (AlGaInAsP), having a thickness of about 1.0 nm to 10 □m. A suitable template for this structure is 1-10 monolayers of zirconium-arsenic (Zr—As), zirconium-phosphorus (Zr—P), hafnium-arsenic (Hf—As), hafnium-phosphorus (Hf—P), strontium-oxygen-arsenic (Sr—O—As), strontium-oxygen-phosphorus (Sr—O—P), barium-oxygen-arsenic (Ba—O—As), indium-strontium-oxygen (In—Sr—O), or barium-oxygen-phosphorus (Ba—O—P), and preferably 1-2 monolayers of one of these materials. By way of an example, for a barium zirconate accommodating buffer layer, the surface is terminated with 1-2 monolayers of zirconium followed by deposition of 1-2 monolayers of arsenic to form a Zr—As template. A monocrystalline layer of the compound semiconductor material from the indium phosphide system is then grown on the template layer. The resulting lattice structure of the compound semiconductor material exhibits a 45 degree rotation with respect to the accommodating buffer layer lattice structure and a lattice mismatch to <100> InP of less than 2.5%, and preferably less than about 1.0%.

### EXAMPLE 3

In accordance with a further embodiment of the invention, a structure is provided that is suitable for the growth of an epitaxial film of a monocrystalline material comprising a II-VI material overlying a silicon substrate. The substrate is preferably a silicon wafer as described above. A suitable accommodating buffer layer material is SrₓBa₁₋ₓTiO₃ (where x ranges from 0 to 1), having a thickness of about 2-100 nm and preferably a thickness of about 5-15 nm. Where the monocrystalline layer comprises a compound semiconductor material, the II-VI compound semiconductor material can be, for example, zinc selenide (ZnSe) or zinc sulfur selenide (ZnSSe). A suitable template for this material system includes 1-10 monolayers of zinc-oxygen (Zn—O) followed by 1-2 monolayers of an excess of zinc followed by the selenidation of zinc on the surface. Alternatively, a template can be, for example, 1-10 monolayers of strontium-sulfur (Sr—S) followed by the ZnSeS.

### EXAMPLE 4

This embodiment of the invention is an example of structure 40 illustrated in FIG. 2. Substrate 22, accommodating buffer layer 24, and monocrystalline material layer 26 can be similar to those described in example 1. In addition, an additional buffer layer 32 serves to alleviate any strains that might result from a mismatch of the crystal lattice of the accommodating buffer layer and the lattice of the monocrystalline material. Buffer layer 32 can be a layer of germanium or a GaAs, an aluminum gallium arsenide (AlGaAs), an indium gallium phosphide (InGaP), an aluminum gallium phosphide (AlGaP), an indium gallium arsenide (InGaAs), an aluminum indium phosphide (AlInP), a gallium arsenide phosphide (GaAsP), or an indium gallium phosphide (InGaP) strain compensated superlattice. In accordance with one aspect of this embodiment, buffer layer 32 includes a GaAsxP1−x superlattice, wherein the value of x ranges from 0 to 1. In accordance with another aspect, buffer layer 32 includes an In_{y}Ga_{1-y}P superlattice, wherein the value of y ranges from 0 to 1. By varying the value of x or y, as the case may be, the lattice constant is varied from bottom to top across the superlattice to create a match between lattice constants of the underlying oxide and the overlying monocrystalline material which in this example is a compound semiconductor material. The compositions of other compound semiconductor materials, such as those listed above, may also be similarly varied to manipulate the lattice constant of layer 32 in a like manner. The superlattice can have a thickness of about 50-500 nm and preferably has a thickness of about 100-200 nm. The template for this structure can be the same of that described in example 1. Alternatively, buffer layer 32 can be a layer of monocrystalline germanium having a thickness of 1-50 nm and preferably having a thickness of about 220 nm. In using a germanium buffer layer, a template layer of either germanium-strontium (Ge—Sr) or germanium-titanium (Ge—Ti) having a thickness of about one monolayer can be used as a nucleating site for the subsequent growth of the monocrystalline material layer which in this example is a compound semiconductor material. The formation of the oxide layer is capped with either a monolayer of strontium or a monolayer of titanium to act as a nucleating site for the subsequent deposition of the monocrystalline germanium. The monolayer of strontium or titanium provides a nucleating site to which the first monolayer of germanium can bond.

### EXAMPLE 5

This example also illustrates materials useful in a structure 40 as illustrated in FIG. 2. Substrate material 22, accommodating buffer layer 24, monocrystalline material layer 26 and template layer 30 can be the same as those described above in example 2. In addition, additional buffer layer 32 is inserted between the accommodating buffer layer and the overlying monocrystalline material layer. The buffer layer, a further monocrystalline material which in this instance comprises a semiconductor material, can be, for example, a graded layer of indium gallium arsenide (InGaAs) or indium aluminum arsenide (InAlAs). In accordance with one aspect of this embodiment, additional buffer layer 32 includes InGaAs, in which the indium composition varies from 0 to about 50%. The additional buffer layer 32 preferably has a thickness of about 10-30 nm. Varying the composition of the buffer layer from GaAs to InGaAs serves to provide a lattice match between the underlying monocrystalline oxide material and the overlying layer of monocrystalline material which in this example is a compound semiconductor material. Such a buffer layer is especially advantageous if there is a lattice mismatch between accommodating buffer layer 24 and monocrystalline material layer 26.

### EXAMPLE 6

This example provides exemplary materials useful in structure 34, as illustrated in FIG. 3. Substrate material 22, template layer 30, and monocrystalline material layer 26 may be the same as those described above in connection with Example 1.

Amorphous layer 36 is an amorphous oxide layer which is suitably formed of a combination of amorphous intermediate layer materials (e.g., layer 28 materials as described above) and accommodating buffer layer materials (e.g., layer 24 materials as described above). For example, amorphous layer 36 may include a combination of SiOx and Sr_{z}Ba_{1-z}TiO₃ (where z ranges from 0 to 1), which combine or mix, at least partially, during an anneal process to form amorphous oxide layer 36.

The thickness of amorphous layer 36 may vary from application to application and may depend on such factors as desired insulating properties of layer 36, type of monocrystalline material comprising layer 26, and the like. In accordance with one exemplary aspect of the present embodiment, layer 36 thickness is about 2 nm to about 100 nm, preferably about 2-10 nm, and more preferably about 5-6 nm.

Layer 38 comprises a monocrystalline material that can be grown epitaxially over a monocrystalline oxide material such as material used to form accommodating buffer layer 24. In accordance with one embodiment of the invention, layer 38 includes the same materials as those comprising layer 26. For example, if layer 26 includes GaAs, layer 38 also includes GaAs. However, in accordance with other embodiments of the present invention, layer 38 may include materials different from those used to form layer 26. In accordance with one exemplary embodiment of the invention, layer 38 is about 1 monolayer to about 100 nm thick.

Referring once again to FIGS. 1-3, substrate 22 is a monocrystalline substrate such as a monocrystalline silicon or gallium arsenide substrate. The crystalline structure of the monocrystalline substrate is characterized by a lattice constant and by a lattice orientation. In similar manner, accommodating buffer layer 24 is also a monocrystalline material and the lattice of that monocrystalline material is characterized by a lattice constant and a crystal orientation. The lattice constants of the accommodating buffer layer and the monocrystalline substrate must be closely matched or, alternatively, must be such that upon rotation of one crystal orientation with respect to the other crystal orientation, a substantial match in lattice constants is achieved. In this context the terms “substantially equal” and “substantially matched” mean that there is sufficient similarity between the lattice constants to permit the growth of a high quality crystalline layer on the underlying layer.

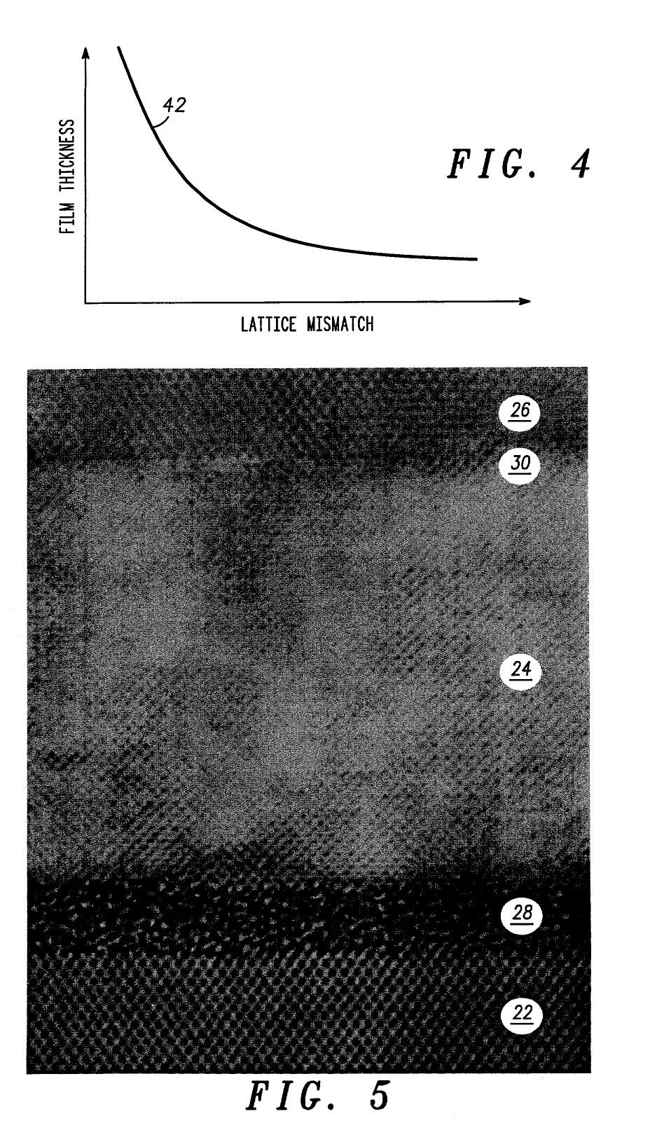

FIG. 4 graphically illustrates the maximum achievable thickness of a grown crystal layer having a high crystalline quality as a function of the degree of mismatch between the lattice constants of a host crystal and a grown crystal. Curve 42 illustrates the boundary of high crystalline quality material. The area to the right of curve 42 represents layers that have a large number of defects. With no lattice mismatch, it is theoretically possible to grow an infinitely thick, high-quality epitaxial layer on a host crystal. As the mismatch in lattice constants between the host crystalline material and the grown crystalline material increases, the maximum attainable thickness of a grown crystalline layer having high crystalline quality decreases rapidly. As a reference point, for example, if the lattice constants between the host crystal and the grown layer are mismatched by more than about 2%, monocrystalline epitaxial layers in excess of about 20 nm cannot be achieved.

In accordance with one embodiment of the invention, substrate 22 is a <100> or <111> oriented monocrystalline silicon wafer and accommodating buffer layer 24 is a layer of strontium barium titanate. Substantial matching of lattice constants between these two materials is achieved by rotating the crystal orientation of the titanate material by 45° with respect to the crystal orientation of the silicon substrate wafer. The inclusion in the structure of amorphous interface layer 28, a silicon oxide layer in this example, if it is of sufficient thickness, serves to reduce strain in the titanate monocrystalline layer that might result from any mismatch in the lattice constants of the host silicon wafer and the grown titanate layer. As a result, in accordance with an embodiment of the invention, a high quality, thick, monocrystalline titanate layer is achievable.

Still referring to FIGS. 1-3, layer 26 is a layer of epitaxially grown monocrystalline material and that crystalline material is also characterized by a crystal lattice constant and a crystal orientation. In accordance with one embodiment of the invention, the lattice constant of layer 26 differs from the lattice constant of substrate 22. To achieve high crystalline quality in this epitaxially grown monocrystalline layer, the accommodating buffer layer must be of high crystalline quality. In addition, in order to achieve high crystalline quality in layer 26, substantial matching between the crystal lattice constant of the host crystal, in this case, the monocrystalline accommodating buffer layer, and the grown crystal is desired. With properly selected materials this substantial matching of lattice constants is achieved as a result of rotation of the crystal orientation of the grown crystal with respect to the orientation of the host crystal. For example, if the grown crystal is gallium arsenide, aluminum gallium arsenide, zinc selenide, or zinc sulfur selenide and the accommodating buffer layer is monocrystalline SrₓBa₁₋ₓTiO₃, substantial matching of crystal lattice constants of the two materials is achieved, wherein the crystal orientation of the grown layer is rotated by 45° with respect to the orientation of the host monocrystalline oxide. Similarly, if the host material is a strontium or barium zirconate or a strontium or barium hafnate or barium tin oxide and the compound semiconductor layer is indium phosphide or gallium indium arsenide or aluminum indium arsenide, substantial matching of crystal lattice constants can be achieved by rotating the orientation of the grown crystal layer by 45° with respect to the host oxide crystal. In some instances, a crystalline semiconductor buffer layer between the host oxide and the grown monocrystalline material layer can be used to reduce strain in the grown monocrystalline material layer that might result from small differences in lattice constants. Better crystalline quality in the grown monocrystalline material layer can thereby be achieved.

The following example illustrates a process, in accordance with one embodiment of the invention, for fabricating a semiconductor structure such as the structures depicted in FIGS. 1-3. The process starts by providing a monocrystalline semiconductor substrate comprising silicon or germanium. In accordance with a preferred embodiment of the invention, the semiconductor substrate is a silicon wafer having a <100> orientation. The substrate is preferably oriented on axis or, at most, about 4° off axis. At least a portion of the semiconductor substrate has a bare surface, although other portions of the substrate, as described below, may encompass other structures. The term “bare” in this context means that the surface in the portion of the substrate has been cleaned to remove any oxides, contaminants, or other foreign material. As is well known, bare silicon is highly reactive and readily forms a native oxide. The term “bare” is intended to encompass such a native oxide. A thin silicon oxide may also be intentionally grown on the semiconductor substrate, although such a grown oxide is not essential to the process in accordance with the invention. In order to epitaxially grow a monocrystalline oxide layer overlying the monocrystalline substrate, the native oxide layer must first be removed to expose the crystalline structure of the underlying substrate. The following process is preferably carried out by molecular beam epitaxy (MBE), although other epitaxial processes may also be used in accordance with the present invention. The native oxide can be removed by first thermally depositing a thin layer of strontium, barium, a combination of strontium and barium, or other alkaline earth metals or combinations of alkaline earth metals in an MBE apparatus. In the case where strontium is used, the substrate is then heated to a temperature of about 750° C. to cause the strontium to react with the native silicon oxide layer. The strontium serves to reduce the silicon oxide to leave a silicon oxide-free surface. The resultant surface, which exhibits an ordered 2×1 structure, includes strontium, oxygen, and silicon. The ordered 2×1 structure forms a template for the ordered growth of an overlying layer of a monocrystalline oxide. The template provides the necessary chemical and physical properties to nucleate the crystalline growth of an overlying layer.

In accordance with an alternate embodiment of the invention, the native silicon oxide can be converted and the substrate surface can be prepared for the growth of a monocrystalline oxide layer by depositing an alkaline earth metal oxide, such as strontium oxide, strontium barium oxide, or barium oxide, onto the substrate surface by MBE at a low temperature and by subsequently heating the structure to a temperature of about 750° C. At this temperature a solid state reaction takes place between the strontium oxide and the native silicon oxide causing the reduction of the native silicon oxide and leaving an ordered 2×1 structure with strontium, oxygen, and silicon remaining on the substrate surface. Again, this forms a template for the subsequent growth of an ordered monocrystalline oxide layer.

Following the removal of the silicon oxide from the surface of the substrate, in accordance with one embodiment of the invention, the substrate is cooled to a temperature in the range of about 200-800° C. and a layer of strontium titanate is grown on the template layer by molecular beam epitaxy. The MBE process is initiated by opening shutters in the MBE apparatus to expose strontium, titanium and oxygen sources. The ratio of strontium and titanium is approximately 1:1. The partial pressure of oxygen is initially set at a minimum value to grow stoichiometric strontium titanate at a growth rate of about 0.3-0.5 nm per minute. After initiating growth of the strontium titanate, the partial pressure of oxygen is increased above the initial minimum value. The overpressure of oxygen causes the growth of an amorphous silicon oxide layer at the interface between the underlying substrate and the growing strontium titanate layer. The growth of the silicon oxide layer results from the diffusion of oxygen through the growing strontium titanate layer to the interface where the oxygen reacts with silicon at the surface of the underlying substrate. The strontium titanate grows as an ordered <100> monocrystal with the <100> crystalline orientation rotated by 45° with respect to the underlying substrate. Strain that otherwise might exist in the strontium titanate layer because of the small mismatch in lattice constant between the silicon substrate and the growing crystal is relieved in the amorphous silicon oxide intermediate layer.

After the strontium titanate layer has been grown to the desired thickness, the monocrystalline strontium titanate is capped by a template layer that is conducive to the subsequent growth of an epitaxial layer of a desired monocrystalline material. For example, for the subsequent growth of a monocrystalline compound semiconductor material layer of gallium arsenide, the MBE growth of the strontium titanate monocrystalline layer can be capped by terminating the growth with 1-2 monolayers of titanium, 1-2 monolayers of titanium-oxygen or with 1-2 monolayers of strontium-oxygen. Following the formation of this capping layer, arsenic is deposited to form a Ti—As bond, a Ti—O—As bond or a Sr—O—As. Any of these form an appropriate template for deposition and formation of a gallium arsenide monocrystalline layer. Following the formation of the template, gallium is subsequently introduced to the reaction with the arsenic and gallium arsenide forms. Alternatively, gallium can be deposited on the capping layer to form a Sr—O—Ga bond, and arsenic is subsequently introduced with the gallium to form the GaAs.

FIG. 5 is a high resolution Transmission Electron Micrograph (TEM) of semiconductor material manufactured in accordance with one embodiment of the present invention. Single crystal SrTiO₃ accommodating buffer layer 24 was grown epitaxially on silicon substrate 22. During this growth process, amorphous interfacial layer 28 is formed which relieves strain due to lattice mismatch. GaAs compound semiconductor layer 26 was then grown epitaxially using template layer 30.

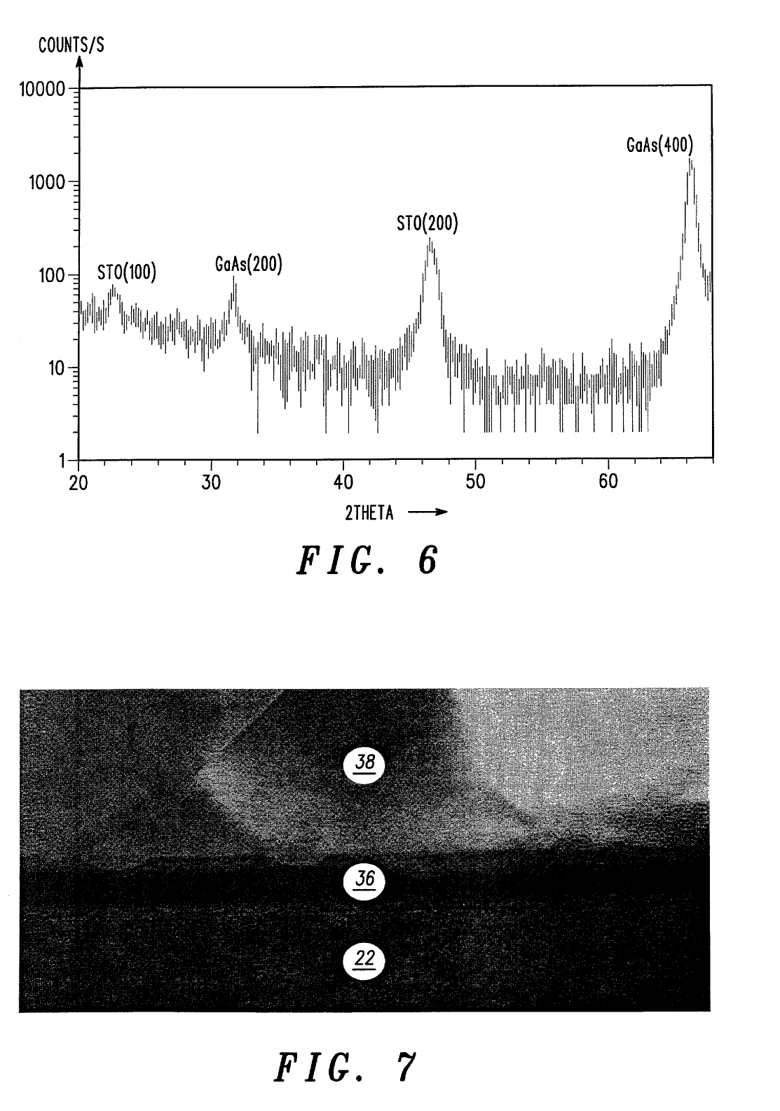

FIG. 6 illustrates an x-ray diffraction spectrum taken on a structure including GaAs monocrystalline layer 26 comprising GaAs grown on silicon substrate 22 using accommodating buffer layer 24. The peaks in the spectrum indicate that both the accommodating buffer layer 24 and GaAs compound semiconductor layer 26 are single crystal and <100> oriented.

The structure illustrated in FIG. 2 can be formed by the process discussed above with the addition of an additional buffer layer deposition step. The additional buffer layer 32 is formed overlying the template layer before the deposition of the monocrystalline material layer. If the buffer layer is a monocrystalline material comprising a compound semiconductor superlattice, such a superlattice can be deposited, by MBE for example, on the template described above. If instead the buffer layer is a monocrystalline material layer comprising a layer of germanium, the process above is modified to cap the strontium titanate monocrystalline layer with a final layer of either strontium or titanium and then by depositing germanium to react with the strontium or titanium. The germanium buffer layer can then be deposited directly on this template.

Structure 34, illustrated in FIG. 3, may be formed by growing an accommodating buffer layer, forming an amorphous oxide layer over substrate 22, and growing semiconductor layer 38 over the accommodating buffer layer, as described above. The accommodating buffer layer and the amorphous oxide layer are then exposed to an anneal process sufficient to change the crystalline structure of the accommodating buffer layer from monocrystalline to amorphous, thereby forming an amorphous layer such that the combination of the amorphous oxide layer and the now amorphous accommodating buffer layer form a single amorphous oxide layer 36. Layer 26 is then subsequently grown over layer 38. Alternatively, the anneal process may be carried out subsequent to growth of layer 26.

In accordance with one aspect of this embodiment, layer 36 is formed by exposing substrate 22, the accommodating buffer layer, the amorphous oxide layer, and monocrystalline layer 38 to a rapid thermal anneal process with a peak temperature of about 700° C. to about 1000° C. and a process time of about 5 seconds to about 10 minutes. However, other suitable anneal processes may be employed to convert the accommodating buffer layer to an amorphous layer in accordance with the present invention. For example, laser annealing, electron beam annealing, or “conventional” thermal annealing processes (in the proper environment) may be used to form layer 36. When conventional thermal annealing is employed to form layer 36, an overpressure of one or more constituents of layer 30 may be required to prevent degradation of layer 38 during the anneal process. For example, when layer 38 includes GaAs, the anneal environment preferably includes an overpressure of arsenic to mitigate degradation of layer 38.

As noted above, layer 38 of structure 34 may include any materials suitable for either of layers 32 or 26. Accordingly, any deposition or growth methods described in connection with either layer 32 or 26, may be employed to deposit layer 38.

FIG. 7 is a high resolution TEM of semiconductor material manufactured in accordance with the embodiment of the invention illustrated in FIG. 3. In accordance with this embodiment, a single crystal SrTiO₃ accommodating buffer layer was grown epitaxially on silicon substrate 22. During this growth process, an amorphous interfacial layer forms as described above. Next, additional monocrystalline layer 38 comprising a compound semiconductor layer of GaAs is formed above the accommodating buffer layer and the accommodating buffer layer is exposed to an anneal process to form amorphous oxide layer 36.

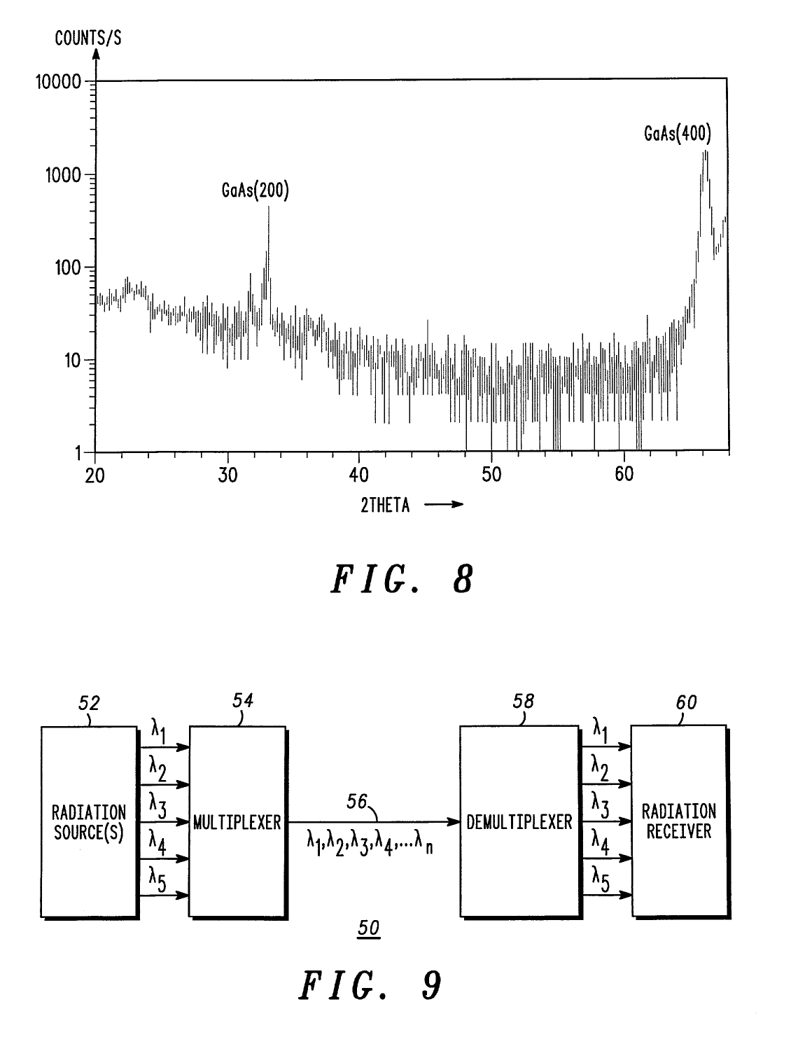

FIG. 8 illustrates an x-ray diffraction spectrum taken on a structure including additional monocrystalline layer 38 comprising a GaAs compound semiconductor layer and amorphous oxide layer 36 formed on silicon substrate 22. The peaks in the spectrum indicate that GaAs compound semiconductor layer 38 is single crystal and <100> oriented, and the lack of peaks around 40 to 50 degrees indicates that layer 36 is amorphous.

The process described above illustrates a process for forming a semiconductor structure including a silicon substrate, an overlying oxide layer, and a monocrystalline material layer comprising a gallium arsenide compound semiconductor layer by the process of molecular beam epitaxy. The process can also be carried out by the process of chemical vapor deposition (CVD), metal organic chemical vapor deposition (MOCVD), migration enhanced epitaxy (MEE), atomic layer epitaxy (ALE), physical vapor deposition (PVD), chemical solution deposition (CSD), pulsed laser deposition (PLD), or the like. Further, by a similar process, other monocrystalline accommodating buffer layers such as alkaline earth metal titanates, zirconates, hafnates, tantalates, vanadates, ruthenates, and niobates, alkaline earth metal tin-based perovskites, lanthanum aluminate, lanthanum scandium oxide, and gadolinium oxide can also be grown. Further, by a similar process such as MBE, other monocrystalline material layers comprising other III-V and II-VI monocrystalline compound semiconductors, semiconductors, metals and non-metals can be deposited overlying the monocrystalline oxide accommodating buffer layer.

Each of the variations of monocrystalline material layer and monocrystalline oxide accommodating buffer layer uses an appropriate template for initiating the growth of the monocrystalline material layer. For example, if the accommodating buffer layer is an alkaline earth metal zirconate, the oxide can be capped by a thin layer of zirconium. The deposition of zirconium can be followed by the deposition of arsenic or phosphorus to react with the zirconium as a precursor to depositing indium gallium arsenide, indium aluminum arsenide, or indium phosphide respectively. Similarly, if the monocrystalline oxide accommodating buffer layer is an alkaline earth metal hafnate, the oxide layer can be capped by a thin layer of hafnium. The deposition of hafnium is followed by the deposition of arsenic or phosphorous to react with the hafnium as a precursor to the growth of an indium gallium arsenide, indium aluminum arsenide, or indium phosphide layer, respectively. In a similar manner, strontium titanate can be capped with a layer of strontium or strontium and oxygen and barium titanate can be capped with a layer of barium or barium and oxygen. Each of these depositions can be followed by the deposition of arsenic or phosphorus to react with the capping material to form a template for the deposition of a monocrystalline material layer comprising compound semiconductors such as indium gallium arsenide, indium aluminum arsenide, or indium phosphide.

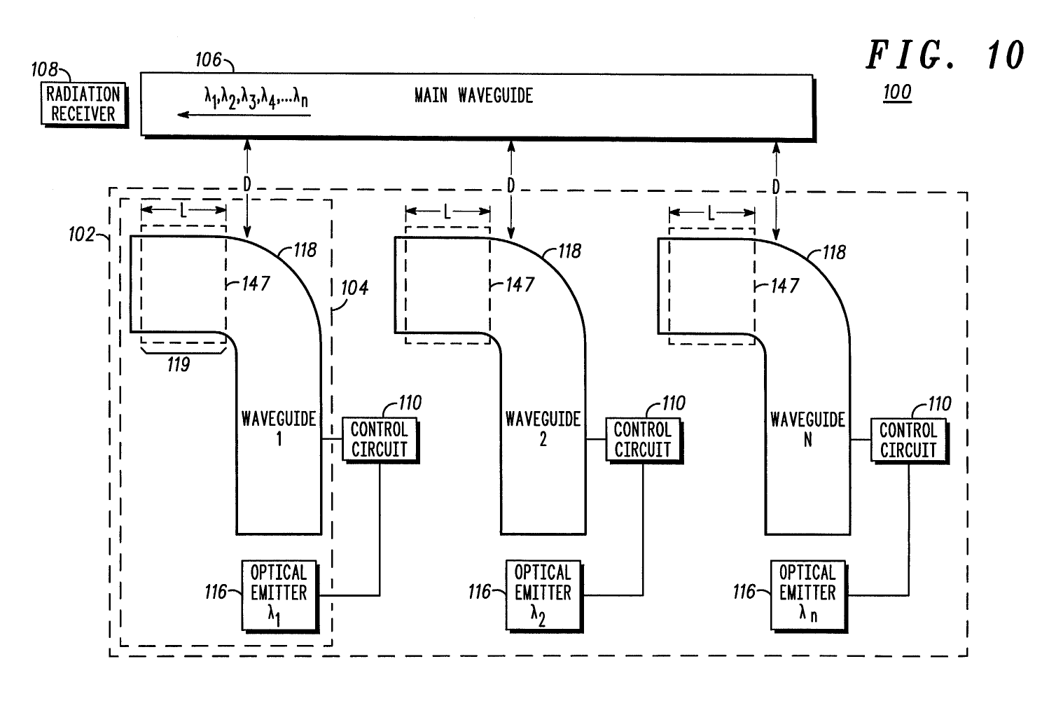

The formation of a device structure in accordance with further embodiments of the invention is illustrated in FIGS. 9-23. Like the previously described embodiments referred to in FIGS. 1-3, these embodiments of the invention involve the process of forming a compliant substrate utilizing the epitaxial growth of single crystal oxides, such as the formation of accommodating buffer layer 24 (previously described with reference to FIGS. 1 and 2) and amorphous layer 36 (previously described with reference to FIG. 3), and the formation of a template layer 30. Further, the device structures depicted in FIGS. 9-23 may be formed by any of the following processes: molecular beam epitaxy (MBE), chemical vapor deposition (CVD), metal organic chemical vapor deposition (MOCVD), migration enhanced epitaxy (MEE), atomic layer epitaxy (ALE), physical vapor deposition (PVD), chemical solution deposition (CSD), pulsed laser deposition (PLD), or the like. As used herein, the term “PVD” shall be understood to include MBE, CVD, MOCVD, MEE, and ALE.

FIG. 9 schematically illustrates a Wavelength Division Multiplexing (WDM) system 50. WDM system 50 comprises a radiation source 52; a multiplexer 54 communicating with an optical device 56, such as a fiber optic cable for example; and a demultiplexer 58 communicating with optical device 56 as well as a plurality of radiation receivers 60. Alternatively, optical device 56 may be removed from the system 50, and an optical beam transmitted by multiplexer 54 may travel through air to the demultiplexer 58. WDM system 50 is a component of an optical network that facilitates the transmission and reception of data between and among locations in the network. Typically, a WDM system transmits and receives data in the form of a plurality of optical carrier signals of distinct wavelengths through a single optical fiber or cable. Thus, WDM system 50 is generally configured to transmit radiation of multiple wavelengths from radiation source 52; combine the multiple wavelengths and send them through optical device 56; receive and separate the radiation according to its wavelength; and then send radiation of a particular wavelength to a corresponding, single-wavelength radiation detector 60.

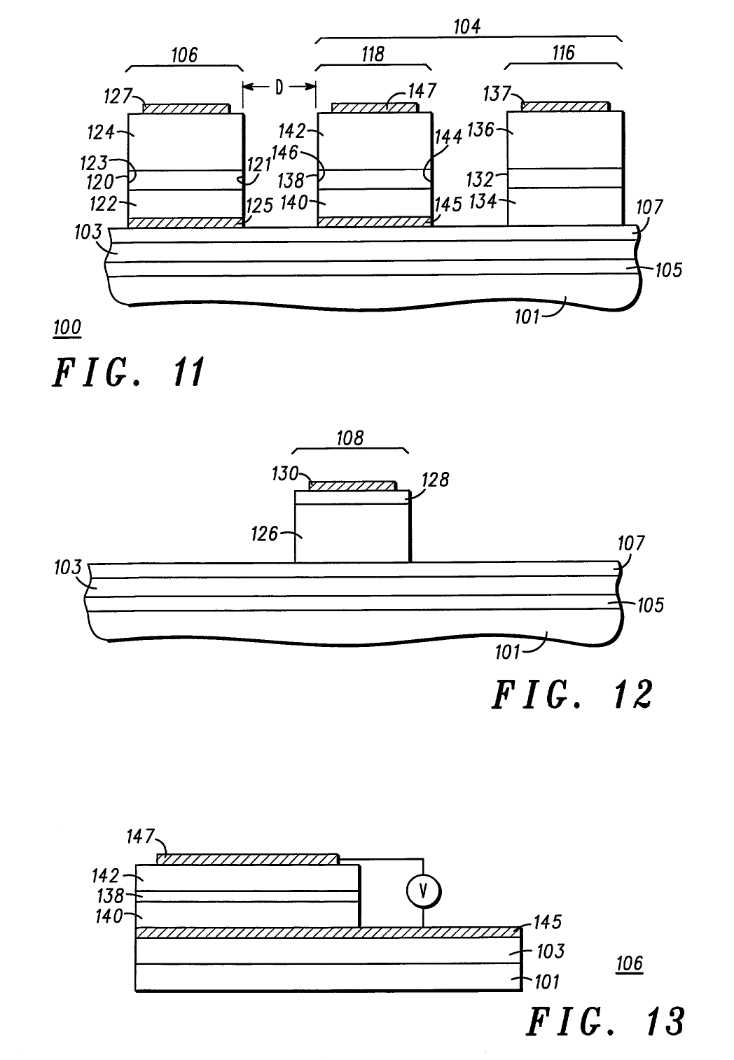

FIG. 10 illustrates a top plan view of an exemplary monolithic, integrated multiplexer system 100 in accordance with an embodiment of the present invention. Multiplexer system 100 comprises a radiation source 102, which further comprises one or more radiation emitter systems 104; a main waveguide 106 adjacent to radiation source 102; a radiation receiver 108 in alignment with main waveguide 106; and a plurality of control circuits 110, each of which is operatively coupled to a corresponding emitter system 104 to control the operation of the emitter system 104. It will be appreciated that while the described embodiment of multiplexer system 100 includes a plurality of control circuits 110, alternate embodiments may include a single integrated control circuit which controls the various devices of multiplexer system 100. Multiplexer system 100 is generally configured to transmit multiple wavelengths of radiation emitted from optical emitters 116 through waveguide 118 and then to the radiation receiver 108 via main waveguide 106.

A cross-sectional view of the exemplary multiplexer system 100 of FIG. 10 is illustrated in FIG. 11. Specifically, FIG. 11 illustrates a cross-sectional view of exemplary embodiments of main waveguide 106 and a radiation emitter system 104 comprising a waveguide 118 and an optical emitter 116. In one embodiment, a structure comprising multiplexer system 100 is formed on a monocrystalline accommodating buffer layer 103 which is positioned over a monocrystalline substrate 101. As described in greater detail below, alternate embodiments of system 100 may also include an amorphous interface layer 105 positioned between substrate 101 and buffer layer 103. Further, multiplexer system 100 may also include a monocrystalline template layer 107 positioned above buffer layer 103. As used herein, the term “monocrystalline” shall have the meaning commonly used within the semiconductor industry. The term shall refer to materials that are a single crystal, or that are substantially a single crystal, and shall include those materials having a relatively small number of defects, such as dislocations and the like, as are commonly found in substrates of silicon or germanium or mixtures of silicon and germanium and epitaxial layers of such materials, as commonly found in the semiconductor industry.

Substrate 101, in accordance with an embodiment of the invention, is a monocrystalline semiconductor or compound semiconductor material. Substrate 101 can comprise, for example, a material from Group IV of the periodic table or a compound material from Groups III and V. Examples of suitable substrate materials include silicon, germanium, mixed silicon and germanium, mixed silicon and carbon, mixed silicon, germanium and carbon, gallium arsenide, indium phosphide, and the like. Preferably, substrate 101 is a wafer comprising silicon or germanium and, most preferably, is a high-quality monocrystalline silicon wafer, as used in the semiconductor industry.

In one embodiment, substrate 101 comprises a <100> or <111> oriented monocrystalline silicon wafer. In another embodiment, substrate 101 may comprise a <001> Group IV material that has been off-cut towards a <110> direction. The growth of material layers on a miscut Si <001> substrate is known in the art. For example, U.S. Pat. No. 6,039,803, issued to Fitzgerald et. al on Mar. 21, 2000, which patent is herein incorporated by reference, is directed to the growth of silicon-germanium and germanium layers on miscut Si <001> substrates. Substrate 101 may be off-cut in the range of from about 2° to about 6° towards the <110> direction. A miscut Group IV substrate reduces dislocations and results in the improved quality of subsequently grown layers.

Monocrystalline accommodating buffer layer 103 is preferably a monocrystalline oxide or nitride material selected for its crystalline compatibility with both the underlying substrate and an overlying material layer. For example, the material comprising buffer layer 103 may be an oxide or nitride having a lattice structure closely matched to the lattice structures of both the substrate 101 and a subsequently deposited compound semiconductor material layer. Materials that are suitable for the buffer layer 103 include metal oxides, such as the alkaline-earth metal titanates, alkaline-earth metal zirconates, alkaline-earth metal hafnates, alkaline-earth metal tantalates, alkaline-earth metal ruthenates, alkaline-earth metal niobates, and alkaline-earth metal vanadates; perovskite oxides, such as alkaline-earth metal tin-based perovskites; and lanthanide series oxides, such as lanthanum aluminate, lanthanum scandium oxide, and gadolinium oxide. Additionally, various nitrides, such as gallium nitride, aluminum nitride, and boron nitride, may also be used for the buffer layer 103. Most of these materials are insulators, though others may be conductors, such as strontium ruthenate for example. Generally, these materials are metal oxides or metal nitrides, and, more particularly, these metal oxides or metal nitrides typically include at least two different metallic elements. In particular applications, the metal oxides or metal nitrides may include three or more different metallic elements. Buffer layer 103 may have a thickness of about 20-1000 Å and preferably has a thickness of about 50-100 Å.

Referring once again to FIG. 11, in accordance with one embodiment of the invention, the structure of system 100 may also include an amorphous interface layer 105 positioned between substrate 101 and buffer layer 103. In one embodiment, amorphous interface layer 105 comprises an oxide formed at the interface between substrate 101 and the buffer layer 103 through the oxidation of the surface of the substrate 101 during the growth of the buffer layer 103. In an exemplary embodiment, amorphous interface layer 105 comprises a silicon oxide. Amorphous interface layer 105 is preferably of sufficient thickness to relieve any strain attributed to lattice mismatch between the lattice constants of substrate 101 and buffer layer 103. By relieving any strain in the buffer layer 103, amorphous interface layer 105 promotes the growth of a high-quality monocrystalline material layer over the buffer layer 103. The combined thickness of buffer layer 103 and amorphous interface layer 105 may be about 20-1000 Å and preferably is about 50-100 Å.

In an alternate embodiment, the structure of system 100 includes an amorphous layer (not shown), rather than an accommodating buffer layer 103 and an amorphous interface layer 105. The amorphous layer may be formed by first forming an accommodating buffer layer and an amorphous interface layer in a similar manner to that described above. The accommodating buffer layer is then exposed to an anneal process to convert the monocrystalline accommodating buffer layer to an amorphous layer. An amorphous layer formed in this manner comprises materials from both the accommodating buffer layer and the amorphous interface layer, which layers may or may not amalgamate. Thus, the final amorphous layer may actually comprise one or two amorphous layers. The formation of such an amorphous layer between substrate 101 and the subsequent monocrystalline material layer relieves any lattice strain between the substrate 101 and the subsequent material layer and provides a true compliant substrate for subsequent processing, such as the formation of radiation source 102 for example. If the structure of system 100 does not include an amorphous layer, such as amorphous interface layer 105 for example, the materials forming substrate 101 and buffer layer 103 are preferably substantially lattice matched to ensure the fabrication of a high-quality device structure.

In accordance with one embodiment of the invention, the structure of system 100 may also include a template layer 107 overlying buffer layer 103. Template layer 107 is a monocrystalline material layer which provides lattice compensation when the lattice constant of the buffer layer 103 cannot be adequately matched to the lattice constant of an overlying monocrystalline material layer. Accordingly, template layer 107 promotes the initiation of epitaxial growth of a subsequently deposited monocrystalline material layer over the buffer layer 103. Template layer 107 is preferably an epitaxially-grown monocrystalline material layer which is formed of a semiconductor or compound semiconductor material. The material for template layer 107 can be selected, as desired, for a particular semiconductor structure or application. For example, the template layer 107 may comprise a compound semiconductor material selected from any of the Group IIIA and VA elements (III-V semiconductor compounds), mixed III-V compounds, Group II(A or B) and VIA elements (II-VI semiconductor compounds), and mixed II-VI compounds. Examples of such compound semiconductor materials include gallium arsenide (GaAs), gallium indium arsenide (GaInAs), gallium aluminum arsenide (GaAlAs), indium phosphide (InP), cadmium sulfide (CdS), mercury cadmium telluride (HgCdTe), zinc selenide (ZnSe), zinc sulfur selenide (ZnSSe), and the like. However, template layer 107 may also comprise other semiconductor materials, metals, or non-metal materials which are used in the formation of semiconductor structures, devices, and/or integrated circuits. Template layer 107 may have a thickness of about 10 Å to about 1 μm and preferably has a thickness of about 500 Å to about 0.5 μm.

In one embodiment, a monocrystalline piezoelectric material layer (not shown) may be positioned over the buffer layer 103 and under an electrode layer (described below) to tune the optical device structures of system 100 piezoelectrically. Generally, the optical properties of optical device structures can be tuned or manipulated by introducing mechanical stress or strain into the crystal structure of the materials forming the optical device structure. One method of inducing lattice strain in a material structure is to place the structure in intimate contact with a piezoelectric material whose lattice constant may be altered through an applied electrical bias. Alteration of the lattice constant of a piezoelectric material that is intimately coupled to an optical device structure transfers mechanical stress to the crystal structure of the material layers comprised by the optical device structure. This induced strain modifies the band structure of the material layers of the structure and, more specifically, the bandgap of the active layer of the optical device structure. In the case of a laser structure, for example, since the bandgap of the lasing material is inversely proportional to the output wavelength or carrier signal of that lasing material layer, altering the bandgap effectively modifies the carrier signal. Alternatively, in the case of a photodetector structure, for example, the bandgap of the active layer of the photodetector structure is inversely proportional to the longest wavelength of the light absorbed by the photodetector. Since the bandgap of the active layer sets the upper limit for the wavelengths of light to which the detector can respond, a photodetector will generate an electrical current in response to the absorption of light which has a wavelength that is either equal to or less than the wavelength which corresponds to the bandgap of the active layer. If the bandgap of the active layer can be altered, then the wavelength(s) of light to which the photodetector can respond also can be altered. Accordingly, the application of an electrical bias to a piezoelectric material layer coupled to an optical device can be used to modify or tune the bandgap of the active layer in the optical device.

Suitable materials for a monocrystalline piezoelectric material layer may include lead zirconium titanate (PZT), lead zirconium niobate—lead titanate (PZN-PT), lead lanthanum zirconium titanate (PLZT), and lead magnesium niobate—lead titanate (PMN-PT). This piezoelectric material layer may be formed by PVD, CSD, or PLD. If patterning is required, suitable photolithographic and/or etching processes may be used, as is known in the art.

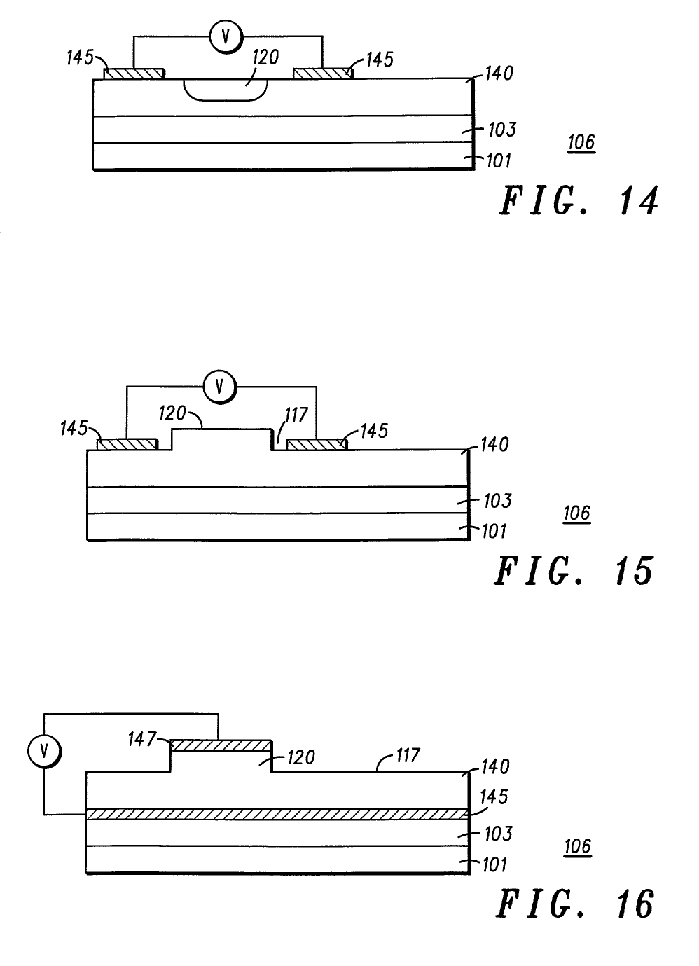

Referring now to FIG. 12, a radiation receiver 108 is illustrated. It will be appreciated that radiation receiver 108 may be formed either on the same substrate as main waveguide 106 or “off-chip” on another substrate. Radiation receiver 108 may be any device capable of receiving electromagnetic radiation. Radiation receiver 108 is generally configured to transmit the light to a receiver system, which can separate the different wavelengths and then convert the optical power to an electrical signal. Suitable radiation receivers may include a photodetector, a diode, a fiber optic cable which will carry the signal to a photodetector, and the like. In accordance with the exemplary embodiment illustrated in FIGS. 10 and 12, radiation receiver 108 is shown as a photodetector receiving one wavelength, and comprises an active layer 128 overlying a monocrystalline material layer 126. Monocrystalline material layer 126 may be epitaxially deposited overlying buffer layer 103 and substrate 101.

Active layer 128 may be formed of a variety of monocrystalline, polycrystalline, or amorphous materials such as silicon, GaAs, or InGaAs. Active layer 128 is preferably an epitaxially-grown monocrystalline material layer which is formed of a semiconductor or compound semiconductor material selected to receive a desired wavelength or desired wavelengths from main waveguide 106. The material for active layer 128 may comprise a compound semiconductor material selected from any of the Group IIIA and VA elements (III-V semiconductor compounds), mixed III-V compounds, Group II(A or B) and VIA elements (II-VI semiconductor compounds), and mixed II-VI compounds. Examples of such compound semiconductor materials include gallium arsenide (GaAs), indium phosphide (InP), aluminum gallium arsenide (AlGaAs), indium gallium arsenide (InGaAs), indium gallium arsenic phosphide (InGaAsP), indium aluminum arsenide phosphide (InAlAsP), indium aluminum gallium arsenide (InAlGaAs), and the like. In one embodiment, active layer 128 has a thickness of about 0.5-10 :m and preferably has a thickness of about 1-1.5 :m. Active layer 128 may be formed by PVD, CSD, or PLD. If patterning is required, suitable photolithographic and/or etching processes may be used, as is known in the art.

Monocrystalline material layer 126 may be selected for its crystalline compatibility with the overlying active layer 128. For example, monocrystalline material layer 126 may be formed of material selected from any of the Group IIIA and VA elements (III-V semiconductor compounds), mixed III-V compounds, Group II(A or B) and VIA elements (II-VI semiconductor compounds), and mixed II-VI compounds. Examples include gallium arsenide (GaAs), gallium antimonide (GaSb), indium gallium arsenide (InGaAs), gallium aluminum arsenide (GaAlAs), aluminum gallium antimonide (AlGaSb), indium phosphide (InP), indium gallium arsenic phosphide (InGaAsP), indium aluminum gallium arsenide (InAlGaAs), cadmium sulfide (CdS), cadmium mercury telluride (CdHgTe), zinc selenide (ZnSe), zinc sulfur selenide (ZnSSe), lead selenide (PbSe), lead telluride (PbTe), lead sulfide selenide (PbSSe), and the like. Monocrystalline material layer 126 may have a thickness of about 100 Å to about 0.5 μm and preferably has a thickness of about 500-1500 Å. Monocrystalline material layer 126 may be formed by PVD, CSD, or PLD. If patterning is required, suitable photolithographic and/or etching processes may be used, as is known in the art.

An electrode layer 130 may be deposited over the active layer 128 of radiation receiver 108 and patterned to form electrode(s) which may be used to operate the radiation receiver 108. Electrode layer 130 may be formed of any suitable conductive material, including metals and oxide materials, which may be deposited by vapor deposition, plating, and the like, as is known in the art. An integrated circuit may also be formed partially or wholly within substrate 101 and coupled via interconnects to the electrode(s) of electrode layer 130 to control the operation of the radiation receiver 108.

Referring once again to FIGS. 10 and 11, in accordance with an embodiment of the invention, main waveguide 106 is configured to receive light coupled from waveguide 118 through the shared cladding region of length L and width D adjacent to the cores of the main waveguide and the waveguide 118. This configuration typically describes a directional coupler. By appropriated designs of the directional coupler geometry, the wavelength of light and the index of refraction, the total power from optical emitter 116 can be transferred to the main waveguide. More specifically, in an exemplary embodiment, main waveguide 106 guides light through a core layer 120 which is positioned between a first cladding layer 122 and a second cladding layer 124. Preferably, main waveguide 106 is configured such that substantially all light received by a first end 121 of main waveguide 106 from waveguide 118 is confined within the core layer 120 during light transmission through the main waveguide 106 to the radiation receiver 108. In other words, the light is preferably transmitted through main waveguide 106 with total internal reflection. To obtain total, or at least substantial, internal reflection, core layer 120 is formed of a material having a different index of refraction than an index of refraction of material that is used to form first and second cladding layers 122 and 124, respectively. More particularly, the index of refraction of core layer 120 is greater than the index of refraction of the materials used to form first and second cladding layers 122 and 124, respectively. In accordance with an exemplary embodiment, material selected for core layer 120 has an index of refraction n₁; material selected for first and second cladding layers 122 and 124 has an index of refraction of n₂; and n₁>n₂.

Suitable materials for first and second cladding layers 122 and 124 include oxides, such as alkaline-earth metal titanates, alkaline-earth metal zirconates, alkaline-earth metal hafnates, alkaline-earth metal tantalates, alkaline-earth metal ruthenates, alkaline-earth metal niobates, and perovskite oxides; nitrides; electro-optically passive polymers; and the like. For example, one or both of layers 122 and 124 may include a monocrystalline oxide such as any of those described above with reference to buffer layer 103. In one embodiment, first and second cladding layers 122 and 124 may be formed of the same material. In another embodiment, first and second cladding layers 122 and 124 are formed of different materials. Preferably, cladding layer 122 is lattice-matched to underlying buffer layer 103 or template layer 107. First and second cladding layers 122 and 124 may be formed by PVD, CSD, or PLD. If patterning is required, suitable photolithographic and/or etching processes may be used, as is known in the art.

In accordance with one embodiment, core layer 120 is formed of an electro-optically active material, either inorganic or organic, whose index of refraction may be controlled through the application of a modulating voltage (V), as illustrated in FIG. 13. Suitable electro-optically active materials may include barium titanate (BaTiO₃), barium strontium titanate (BaₓSr₁₋ₓTiO₃, where the value of x ranges from 0 to 1), lithium niobate (LiNbO₃), lithium tantalate (LiTaO₃), lead zirconium titanate (Pb(Zr, Ti)O₃), zinc oxide (ZnO₃), lead lanthanum zirconate titanate (Pb(La, Zr, Ti)O₃), and electro-optically active polymers. In an exemplary embodiment, core layer 120 may comprise an electro-optically active material, such as lead zirconium titanate for example, which is doped with a material (e.g., an impurity). First and second cladding layers 122 and 124 may then each include another material, such as lead lanthanum zirconate titanate for example, such that the refractive index of first and second cladding layers 122 and 124, respectively, is less than the refractive index of core layer 120. In one embodiment, first and second cladding layers 122 and 124 are lattice-matched to the core layer 120. Core layer 120 may be formed by PVD, CSD, or PLD. If patterning is required, suitable photolithographic and/or etching processes may be used, as is known in the art.

As illustrated in FIGS. 11 and 13, a first electrode layer 145 may be deposited over buffer layer 103 and/or template layer 107, and a second electrode layer 147 may be formed, e.g., depositing or epitaxially growing, over the second cladding layer 142 of main waveguide 118. Each of first and second electrode layers 145 and 147 may be patterned to form electrode(s) which may be used to operate the waveguide 118 and to control the index of refraction of waveguide 118 through the application of a modulating voltage. First and second electrode layers 145 and 147 may be formed of any suitable conductive material, including metals and oxide materials, which may be deposited by vapor deposition, plating, and the like, as is known in the art. An integrated circuit may also be formed partially or wholly within substrate 101 and coupled via interconnects to the electrode(s) of electrode layers 125 and 127 to control the operation of the waveguide 118.

In one embodiment, if first electrode layer 145 has a refractive index N₂, such that n₂<n₁ (i.e., where n₁ is the refractive index of core layer 138, as described above), then first cladding layer 140 may be replaced by first electrode layer 145. In an exemplary embodiment, first and second electrode layers 145 and 147 may each comprise lanthanum nickel oxide (LaNiO₃). In this embodiment, first electrode layer 145 is preferably lattice-matched to the underlying buffer layer 103. Since the index of refraction of LaNiO₃ is sufficiently low, LaNiO₃ provides adequate optical isolation of the silicon substrate, and first cladding layer 122 need not be included in the structure of main waveguide 106. In this embodiment, electrode layers 145 and 147 may be formed by PVD, CSD, or PLD. If patterning is required, suitable photolithographic and/or etching processes may be used, as is known in the art.

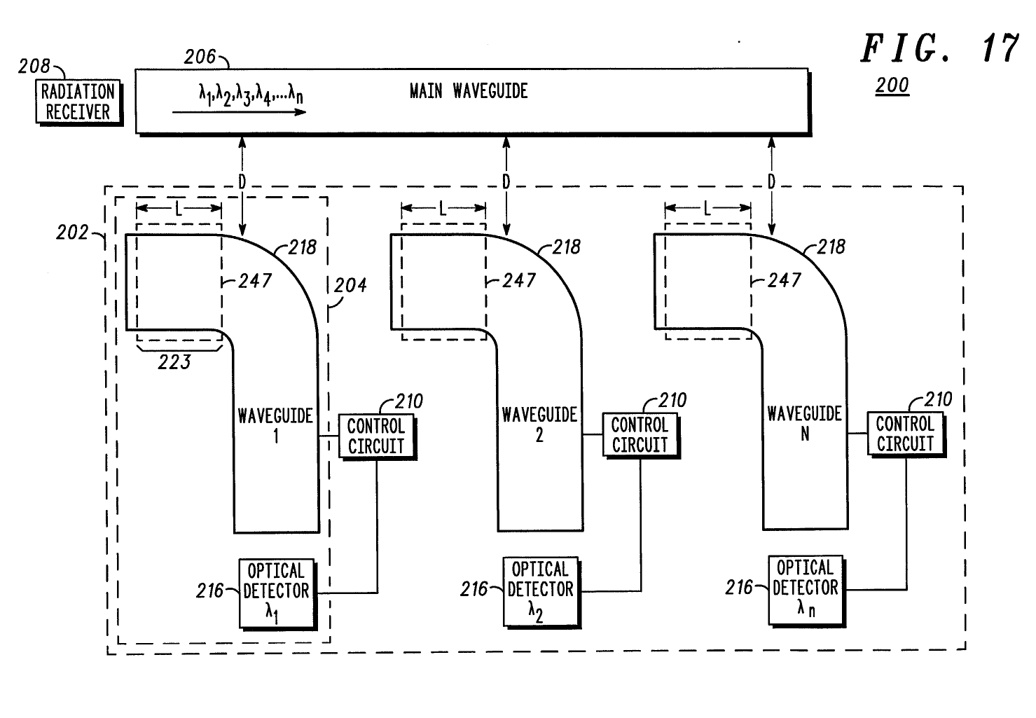

In another exemplary embodiment, illustrated in FIG. 14, a cladding layer 140 may be ion implanted or selectively doped with a pattern of an impurity dopant, such as titanium or protons derived from water vapor phase diffusion for example, to change the index of refraction of the implanted layer 120. For example, a cladding layer 122 comprising lithium niobate or lithium tantalate may be doped with titanium or protons derived from water vapor phase diffusion, such that the refractive index of the cladding layer 122 is less than the refractive index of the implanted (core) layer 120. An electrode layer 125 may be deposited over the cladding layer 140 of waveguide 118 and patterned to form electrode(s) which may be used to operate the waveguide 118 and to control the index of refraction of waveguide 118 through the application of a modulating voltage. Electrode layer 125 may be formed of any suitable conductive material, including metals and oxide materials, which may be deposited by vapor deposition, plating, and the like, as is known in the art. An integrated circuit may also be formed partially or wholly within substrate 101 and coupled via interconnects to the electrode(s) of electrode layer 125 to control the operation of the main waveguide 106.

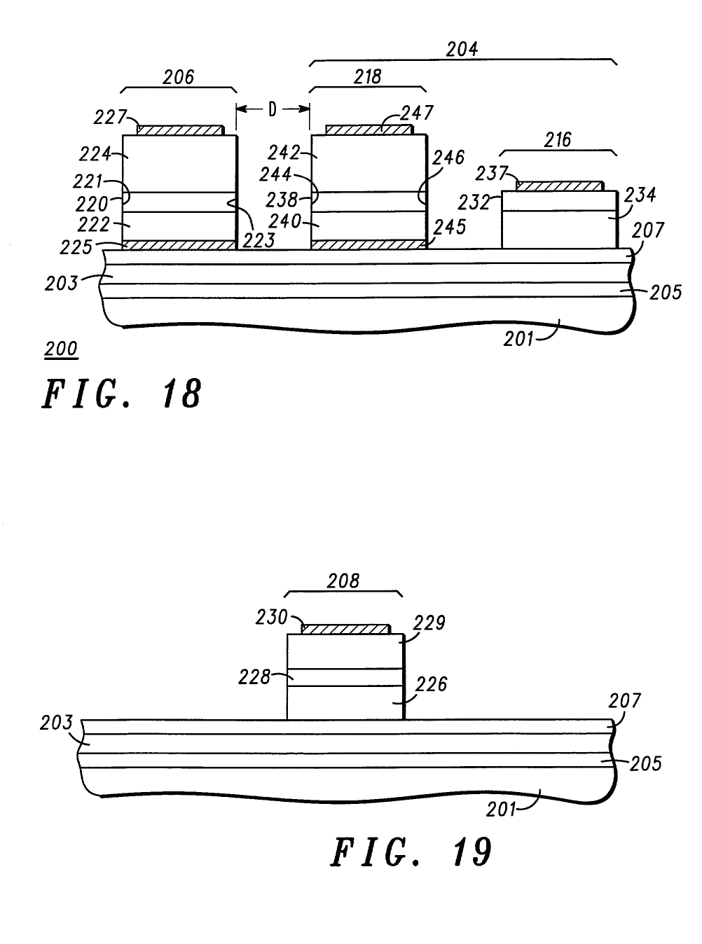

In accordance with further embodiments, as illustrated in FIGS. 15 and 16, a top surface 117 of a base layer 140 may be selectively etched to form a spatial variation in the thickness of the etched base layer 140, thereby forming a ridge 120 above the base layer 140. The ridge 120 forms a light guiding region where the surface of ridge 120 is in contact with air. Alternatively, a lower refractive index material may be subsequently deposited over ridge 120 by PVD, for example. As illustrated in FIG. 15, an electrode layer 125 may be deposited over the base layer 140 of waveguide 118 and patterned to form electrode(s) which may be used to operate the main waveguide 106 and to control the index of refraction of waveguide 118 through the application of a modulating voltage. Alternatively, as illustrated in FIG. 16, a first electrode layer 145 may be deposited over buffer layer 103, and a second electrode layer 147 may be deposited over the ridge 120 of waveguide 118. Each of the first and second electrode layers 145 and 147 may be patterned to form electrode(s) which may be used to operate the waveguide 118 and to control the index of refraction of waveguide 118 through the application of a modulating voltage. Electrode layer 145 of FIG. 15 and first and second electrode layers 145 and 147 of FIG. 16 may each be formed of any suitable conductive material, including metals and oxide materials, which may be deposited by vapor deposition, plating, and the like, as is known in the art. An integrated circuit may also be formed partially or wholly within substrate 101 and coupled via interconnects to the electrode(s) of electrode layer 145 of FIG. 15 or first and second electrode layers 145 and 147 of FIG. 16 to control the operation of the waveguide 118.

With momentary reference to FIG. 10, in accordance with an embodiment of the invention, radiation source 102 is configured to emit electromagnetic radiation of various wavelengths. In one embodiment, radiation source 102 comprises one or more light sources, such as one or more lasers (e.g., edge-emitting lasers or surface-emitting lasers) or light emitting diodes for example, wherein each light source produces and emits a single wavelength of light. Alternatively, the light sources of radiation source 102 may each be capable of producing and emitting a spectrum of radiation including multiple wavelengths, such as λ₁, λ₂, λ₃, λ₄, and λₙ for example. In an exemplary embodiment, radiation source 102 includes one or more emitter systems 104 and preferably includes a plurality of emitter systems 104 formed in parallel on a single substrate.

In an exemplary embodiment, each emitter system 104 comprises an optical emitter 116 and an electro-optical waveguide 118. Optical emitter 116 may be integrated with waveguide 118 or may be a discrete component overlying substrate 101. In the embodiment depicted in FIG. 11, optical emitter 116 comprises an edge-emitting laser, such as a distributed feedback laser or a distributed Bragg reflector for example, though it will be appreciated that other radiation sources, including other laser structures, such as a surface-emitting laser structure, light emitting diodes (LEDs), optical fibers, or waveguides may be substituted in multiplexer system 100 and still fall within the ambit of the appended claims. Optical emitter 116 may include a plurality of radiation emitting devices (e.g., in an array) or a fiber optic cable carrying radiation having a plurality of wavelengths.

In one embodiment, optical emitter 116 comprises an active layer 132 positioned between a first cladding layer 134 and a second cladding layer 136. Layers 132-136 may be formed of any suitable semiconductor material. The material for each of the layers 132-136 can be selected, as desired, for a particular semiconductor structure or application. For example, each of layers 132-136 may comprise compound semiconductor materials independently selected from any of the Group IIIA and VA elements (III-V semiconductor compounds), mixed Ill-V compounds, Group II(A or B) and VIA elements (II-VI semiconductor compounds), and mixed II-VI compounds. Examples of such compound semiconductor materials include gallium arsenide (GaAs), gallium indium arsenide (GaInAs), gallium aluminum arsenide (GaAlAs), indium phosphide (InP), cadmium sulfide (CdS), mercury cadmium telluride (HgCdTe), zinc selenide (ZnSe), zinc sulfur selenide (ZnSSe), and the like. However, each of the layers 132-136 may also comprise other semiconductor materials, metals, or non-metal materials which are used in the formation of semiconductor structures, devices, and/or integrated circuits. In one embodiment, optical emitter 116 may comprise an overall thickness of about 1-10 μm and preferably comprises a thickness of about 2-5 μm. Each of layers 132-136 may be formed by PVD, CSD, or PLD. If patterning is required, suitable photolithographic and/or etching processes may be used, as is known in the art.

In an exemplary embodiment, first cladding layer 134 may include n-type doped AlGaAs, active layer 132 may include GaAs, and second cladding layer 136 may include p-type doped AlGaAs, wherein each of layers 132-136 is epitaxially formed over buffer layer 103 and substrate 101. Although not illustrated in the drawing figures, optical emitter 116 may also include insulating layers to facilitate electrical isolation of optical emitter 116, components thereof, and/or conducting layers to facilitate the coupling of optical emitter 116 to other devices or components.

In another embodiment, an electrode layer 137 may be deposited over the second cladding layer 136 of optical emitter 116 and patterned to form electrode(s) which may be used to operate the optical emitter 116 and to tune the output wavelength of optical emitter 116. Electrode layer 137 may be formed of any suitable conductive material, including metals and oxide materials, which may be deposited by vapor deposition, plating, and the like, as is known in the art. Integrated circuits 110, shown in FIG. 10, may also be formed partially or wholly within substrate 101 and coupled via interconnects to the electrode(s) to control the operation of the optical emitter 116.

In accordance with an embodiment of the invention, electro-optical waveguide 118 is configured to combine and transmit radiation emitted from optical emitter 116 to main waveguide 106 for ultimate transmission to radiation receiver 108. In one embodiment, waveguide 118 comprises a core layer 138 which is positioned between a first cladding layer 140 and a second cladding layer 142. In this embodiment, waveguide 118 guides light through a core layer 138 in a manner similar to that described above with reference to main waveguide 106 and core layer 120 of FIG. 11. Preferably, waveguide 118 is configured such that substantially all light received by a first end 144 of waveguide 118 from optical emitter 116 is confined within the core layer 138 during light transmission through the waveguide 118 and toward a second end 146 of waveguide 118. In other words, the light is preferably transmitted through the waveguide 118 with total internal reflection, as described above. In an exemplary embodiment, material selected for core layer 138 has an index of refraction n₁; material selected for first and second cladding layers 140 and 142 has an index of refraction of n₂; and n₁>n₂. Layers 138-142 are substantially similar to layers 120-124 of FIG. 11 and may be formed of any of the materials or by any of the processes described above with reference to layers 120-124 of main waveguide 106. Additionally, in alternate embodiments, waveguide 118 may be formed in accordance with any of the embodiments of main waveguide 106 described above with reference to FIGS. 13-16.

In an exemplary embodiment, waveguide 118 comprises a directional coupler. A coupler region 119 of waveguide 118 is parallel to the main waveguide 106 and has a length L. The core layers 120 and 138 of main waveguide 106 and waveguide 118, respectively, are separated by the respective cladding layers of main waveguide 106 and waveguide 118 over a distance D. In other words, main waveguide 106 and waveguide 118 share a common cladding layer over the length L. For a given index of refraction n₁ of the core layer, a given index of refraction n₂ of the cladding layer, a given L, a given D, and a given wavelength, an optical beam of the given wavelength initially propagating in waveguide 118 is transferred to main waveguide 106 in a known periodic manner by the directional coupler. Appropriate selection of L, D, n₁, and n₂ provides for an efficient transfer to the main waveguide 106 of the wavelength of the optical beam initially propagating in waveguide 118.

In one embodiment, a first electrode layer 145 may be formed overlying buffer layer 103 or template layer 107, and a second electrode layer 147 may be formed overlying second cladding layer 142. First and second electrode layers 145 and 147 may be patterned to form electrode(s) which may be used to tune the waveguide 118 by manipulating the index of refraction of core layer 138 and selectively coupling light emitted from optical emitter 116 to the main waveguide 106. First and second electrode layers 145 and 147 are substantially similar to first and second electrode layers 125 and 127 of main waveguide 106 and may be formed of any of the materials and by any of the processes described with reference to first and second electrode layers 125 and 127. Integrated circuits 110, as shown in FIG. 10, may also be formed partially or wholly within substrate 101 and coupled via interconnects to the electrode(s) to control the operation of the waveguide 118.

Generally, if the output wavelength of optical emitter 116 changes over time due to aging or temperature effects; if the refractive indices n₁ and n₂ of the core layer and cladding layers, respectively, of the waveguide 118 change with temperature; or if the spacing D changes between the cores 120 and 138 due to the effects of thermal expansion, the electrodes of electrode layers 145 and 147, which have a length L and are positioned within the coupler region 119 of waveguide 118, can be adjusted to modify the refractive index n₁ of the core layer 138 of waveguide 118. The modification of the refractive index through an applied voltage can be used to offset the effects of environmental changes, thereby permitting the coupling of a substantially complete signal from waveguide 118 to main waveguide 106. Alternatively, to accommodate system architectures which may prefer to prevent a certain wavelength from entering the main waveguide 106 at particular intervals, a voltage may be applied across the electrodes of electrode layers 145 and 147 to prevent an optical beam from entering the main waveguide 106 from waveguide 118.

In one embodiment, if first electrode layer 145 has a refractive index n₂ such that n₂<n₁ (i.e., where n₁ is the refractive index of core layer 138, as described above), then first cladding layer 140 may be replaced by first electrode layer 145. In an exemplary embodiment, first and second electrode layers 145 and 147 may each comprise lanthanum nickel oxide (LaNiO₃). In this embodiment, first electrode layer 145 is preferably lattice-matched to the underlying buffer layer 103. Since the index of refraction of LaNiO₃ is sufficiently low, LaNiO₃ provides adequate optical isolation of the silicon substrate 101, and first cladding layer 140 need not be included in the structure of waveguide 118.

FIG. 17 illustrates a top plan view of an exemplary monolithic, integrated demultiplexer system 200 in accordance with an embodiment of the present invention. Demultiplexer system 200 comprises a radiation receiver 202 which further comprises one or more radiation detector systems 204; a main waveguide 206 adjacent to radiation receiver 202; a radiation source 208 in alignment with main waveguide 206; and a plurality of control circuits 210, each of which is operatively coupled to a corresponding radiation detector system 204 to control the operation of the radiation detector system 204. It will be appreciated that while the described embodiment of demultiplexer system 200 includes a plurality of control circuits 210, alternate embodiments may include a single integrated control circuit which controls the various devices of demultiplexer system 200. Demultiplexer system 200 is generally configured to transmit radiation having multiple wavelengths from radiation source 208 through main waveguide 206 and then to separate the radiation by wavelength at each of the waveguides 218, sending radiation of a particular wavelength or wavelengths to each of the optical detectors 216.

A cross-sectional view of the integrated demultiplexer system 200 of FIG. 17 is illustrated in FIG. 18. Specifically, FIG. 18 illustrates a cross-sectional view of exemplary embodiments of a main waveguide 206 and a radiation detector system 204 comprising an optical detector 216 and a waveguide 218. In one embodiment, a structure comprising demultiplexer system 200 is formed on a monocrystalline accommodating buffer layer 203 which is positioned over a monocrystalline substrate 201. As described in greater detail below, one embodiment of system 200 may also include an amorphous interface layer 205 positioned between substrate 201 and buffer layer 203. In another embodiment, system 200 may also include a monocrystalline template layer 207 positioned above buffer layer 203.

Substrate 201 is substantially similar to substrate 101 of FIG. 11 and may comprise any of the materials described above with reference to substrate 101. Accommodating buffer layer 203 is substantially similar to accommodating buffer layer 103 of FIG. 11 and may comprise any of the materials described above with reference to buffer layer 103. In accordance with an embodiment of the invention, system 200 may optionally include an amorphous intermediate layer 205 positioned between substrate 201 and buffer layer 203. The amorphous intermediate layer 205 may comprise any the materials previously described with reference to amorphous intermediate layer 105 of FIG. 11. Additionally, system 200 may comprise an amorphous layer, as described above, rather than an amorphous intermediate layer 205. If system 200 does not include an amorphous layer, such as amorphous intermediate layer 205 for example, the substrate 201 and buffer layer 203 are preferably substantially lattice matched to ensure the fabrication of a high-quality demultiplexer. Additionally, if system 200 includes a template layer 207, template layer 207 is substantially similar to template layer 107 of FIG. 11 and may comprise any of the materials and be formed by any of the processes described above with reference to template layer 107. Moreover, system 200 may optionally include a monocrystalline piezoelectric material layer positioned over the buffer layer 203 and under an electrode layer, as described above with reference to FIG. 11. This piezoelectric material layer may comprise any of the materials and be formed by any of the processes described above with reference to the optional piezoelectric material layer.

In accordance with an embodiment of the invention, main waveguide 206 is configured to transmit and guide light emitted by radiation source 208 to a location away from radiation source 208. More specifically, in an exemplary embodiment, main waveguide 206 guides light through a core layer 220 which is positioned between a first cladding layer 222 and a second cladding layer 224. Preferably, main waveguide 206 is configured such that substantially all light received by a first end 221 of main waveguide 206 from radiation source 208 is confined within the core layer 220 during light transmission through the main waveguide 206 and toward a second end 223 of main waveguide 206. In other words, the light is preferably transmitted through main waveguide 206 with total internal reflection. To obtain total, or at least substantial, internal reflection, core layer 220 is formed of a material having a different index of refraction than an index of refraction of material that is used to form first and second cladding layers 222 and 224, respectively. More particularly, the index of refraction of core layer 220 is greater than the index of refraction of the materials used to form first and second cladding layers 222 and 224, respectively. In one embodiment, first and second cladding layers 222 and 224 may suitably be formed of the same material. In another embodiment, first and second cladding layers 222 and 224 may be formed of different materials. In accordance with an exemplary embodiment, material selected for core layer 220 has an index of refraction n₁; material selected for first and second cladding layers 222 and 224 has an index of refraction of n₂; and n₁>n₂.

Main waveguide 206 is substantially similar to main waveguide 106 of FIGS. 10 and 11 and may comprise any of the materials and may be formed by any of the processes described with reference to main waveguide 106. Specifically, core layer 220 is substantially similar to core layer 120 of FIG. 11 and may comprise any of the materials and be formed by any of the processes described with reference to core layer 120. First and second cladding layers 222 and 224 are substantially similar to first and second cladding layers 122 and 124 of FIG. 11 and may comprise any of the materials and be formed by any of the processes described with reference to first and second cladding layers 122 and 124.

In one embodiment, a first electrode layer 225 may be deposited over buffer layer 203 or template layer 207, and a second electrode layer 227 may be deposited over the second cladding layer 224 of main waveguide 206. First and second electrode layers 225 and 227 may be patterned to form electrode(s) which may be used to operate the main waveguide 206. First and second electrode layers 225 and 227 are substantially similar to first and second electrode layers 125 and 127 of FIG. 11 and may be formed of any of the materials and by any of the processes described with reference to first and second electrode layers 125 and 127. An integrated circuit may also be formed partially or wholly within substrate 201 and coupled via interconnects to the electrode(s) to control the operation of the main waveguide 225.

Referring now to FIG. 19, a radiation source 208 is illustrated. It will be appreciated that radiation source 208 may be formed either on the same substrate as main waveguide 206 or “off-chip” on another substrate. Radiation source 208 may be configured to emit electromagnetic radiation of various wavelengths and transmit that radiation to other devices on substrate 201. Radiation source 208 may comprise one or more radiation emitting devices (e.g., in an array), such as one or more lasers (e.g., edge-emitting lasers or surface-emitting lasers), light emitting diodes, waveguides, or fiber optic cables, for example, wherein each radiation emitting device produces and emits radiation of a single wavelength. Alternatively, the radiation emitting devices may each be capable of producing and emitting a spectrum of radiation including multiple wavelengths, such as λ₁, λ₂, λ₃, λ₄, and λₙ for example.

In one embodiment, radiation source 208 is substantially similar to optical emitter 116 of FIG. 11 and may comprise any of the materials and be formed by any of the processes described with reference to optical emitter 116. Specifically, radiation source 208 comprises an active layer 228 positioned between a first cladding layer 226 and a second cladding layer 229. Active layer 228 is substantially similar to active layer 132 of FIG. 11 and may comprise any of the materials and be formed by any of the processes described with reference to active layer 132. First and second cladding layers 226 and 229 are substantially similar to first and second cladding layers 134 and 136, respectively, of FIG. 11 and may comprise any of the materials and be formed by any of the processes described with reference to first and second cladding layers 134 and 136.

In one embodiment, an electrode layer 230 may be deposited over the second cladding layer 229 and patterned to form electrode(s) which may be used to operate the radiation source 208 and to tune the output wavelengths of radiation source 208. Electrode layer 230 may be formed of any suitable conductive material, including metals and oxide materials, which may be deposited by vapor deposition, plating, and the like, as is known in the art. An integrated control circuit may also be formed partially or wholly within substrate 201 and coupled via interconnects to the electrode(s) of electrode layer 230 to control the operation of the radiation source 208.

In accordance with an aspect of the embodiment illustrated in FIGS. 17 and 18, each radiation detector system 204 comprises an optical detector 216 and an electro-optical waveguide 218. In the embodiment depicted in FIG. 18, optical detector 216 comprises a photodetector, though it will be appreciated that other optical detectors, photodiodes, avalanche photodiodes, and the like may be substituted in demultiplexer system 200 and still fall within the ambit of the appended claims.

Optical detector 216 may be any device capable of receiving electromagnetic radiation. Optical detector 216 is generally configured to convert light received from waveguide 218 into an electrical signal. In accordance with the exemplary embodiment illustrated in FIG. 18, optical detector 216 includes an active layer 232 and a monocrystalline material layer 234. Active layer 232 is substantially similar to active layer 128 of FIG. 12 and may comprise any of the materials and be formed by any of the processes described with reference to layer 128. Monocrystalline material layer 234 is substantially similar to monocrystalline material layer 126 of FIG. 12 and may comprise any of the materials and be formed by any of the processes described with reference to layer 126.

In accordance with an embodiment of the invention, the directional coupler consisting of main waveguide 206 and waveguide 218 where they share a cladding of length L and width D, is configured to separate radiation of a particular wavelength or wavelengths from a stream of radiation, such as radiation being transmitted along main waveguide 206, and to transmit that particular wavelength(s) to optical detector 216. The directional coupler of system 200 is substantially similar to the directional coupler described above with reference to waveguide 118 of FIG. 11.

In one embodiment, waveguide 218 guides light through a core layer 238 in a manner similar to that described above with reference to waveguide 118 and core layer 138 of FIG. 11. Waveguide 218 comprises a core layer 238 which is positioned between a first cladding layer 240 and a second cladding layer 242. Preferably, waveguide 218 is configured such that substantially all light received by a first end 244 from main waveguide 206 is confined within the core layer 238 during light transmission through the waveguide 218 and toward a second end 246 of waveguide 218. In other words, the light is preferably transmitted through the waveguide 218 with total internal reflection, as described above. In an exemplary embodiment, material selected for core layer 238 has an index of refraction n₁; material selected for first and second cladding layers 240 and 242 has an index of refraction of n₂; and n₁>n₂. Layers 238-242 are substantially similar to layers 138-142 of FIG. 11 and may be formed of any of the materials and by any of the processes described with reference to layers 138-142.

In one embodiment, a first electrode layer 245 may be formed overlying buffer layer 203 or template layer 207, and a second electrode layer 247 may be formed overlying second cladding layer 242. First and second electrode layers 245 and 247 may be patterned to form electrode(s) which may be used to tune the waveguide 218 by manipulating the index of refraction of core layer 238 and selectively separating particular wavelengths of light away from main waveguide 206 for transmission to the optical detector 216. First and second electrode layers 245 and 247 are substantially similar to first and second electrode layers 125 and 127 of main waveguide 106 and may be formed of any of the materials and by any of the processes described with reference to first and second electrode layers 125 and 127. Integrated control circuits 210, shown in FIG. 17, may also be formed partially or wholly within substrate 201 and coupled via interconnects to the electrode(s) to control the operation of the waveguide 218.

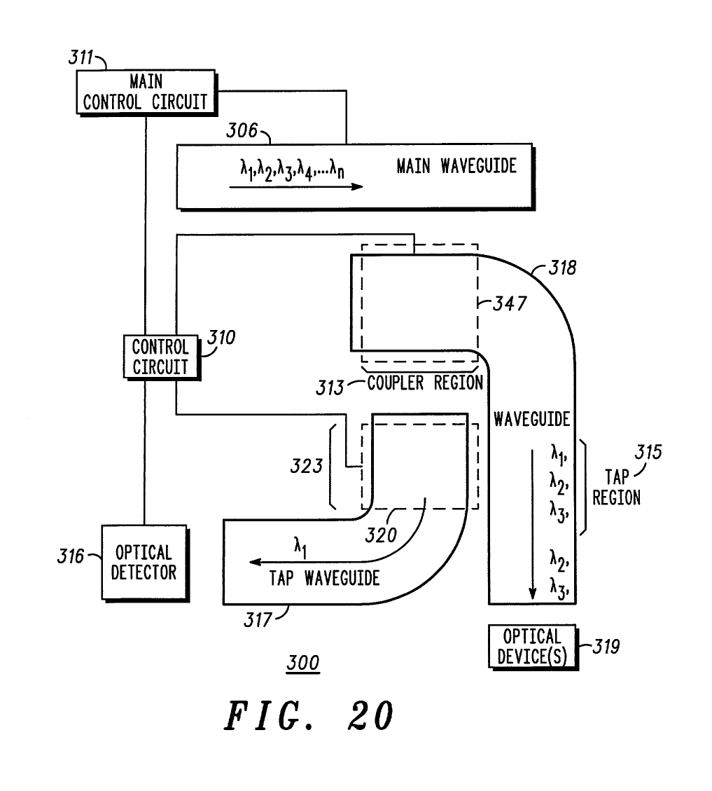

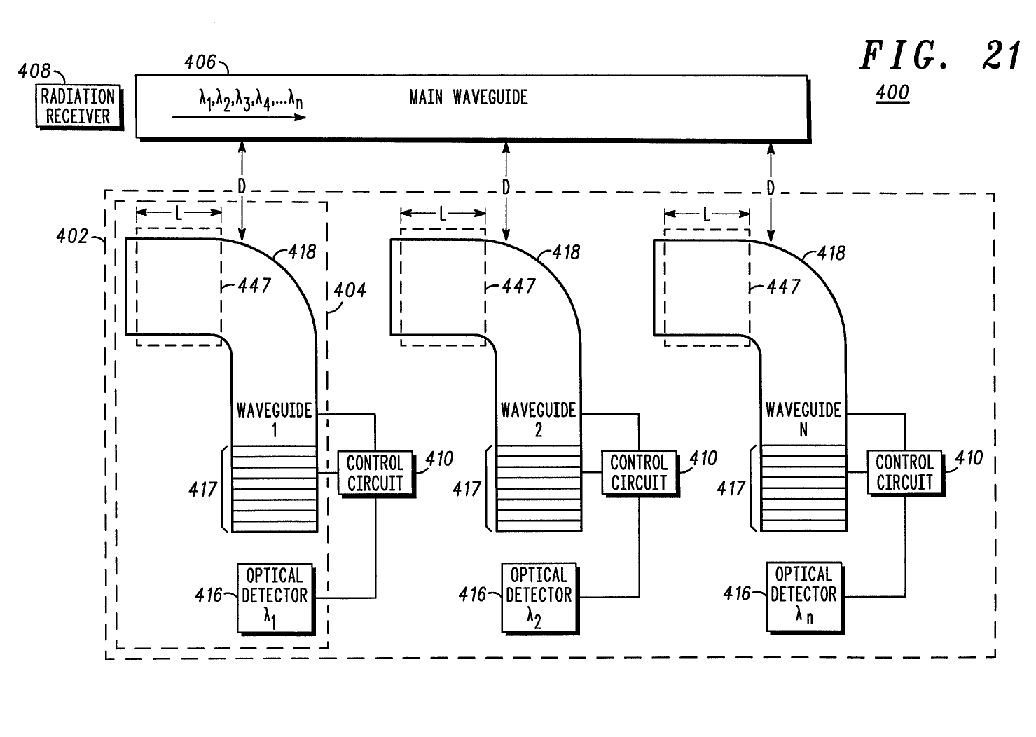

FIG. 20 schematically illustrates a portion of a demultiplexer system 300 which includes two waveguides that are serially positioned to provide additional wavelength separation or optical feedback for tuning control. Demultiplexer system 300 comprises a main waveguide 306; a waveguide 318 adjacent to main waveguide 306; a tap waveguide 317 adjacent to waveguide 318; an optical detector 316; at least one optical device 319; a control circuit 310 electrically connected to waveguide 318, optical detector 316, and tap waveguide 317; and a main control circuit 311 electrically connected to main waveguide 306 and control circuit 310.

Main waveguide 306, waveguide 318, optical detector 316, and control circuit 310 are substantially similar to main waveguide 206, waveguide 218, optical detector 216, and control circuit 210, respectively, described above with reference to FIGS. 17 and 18. Tap waveguide 317 is substantially similar to waveguide 218 of FIGS. 17 and 18 and may comprise any of the materials and be formed by any of the processes described with reference to waveguide 218. In an exemplary embodiment, tap waveguide 317 comprises a directional coupler. Moreover, tap waveguide may be controlled by control circuit 310 in a similar manner to waveguide 318. In one embodiment, control circuit 310 optimizes the voltage to electrode layers 321 and/or 347 to maximize a coupling efficiency of waveguide 318 and/or tap waveguide 317.

As illustrated in FIG. 20, waveguide 318 functions to separate from main waveguide 306 a subset (e.g., λ₁, λ₂, and λ₃) of the multiple wavelengths of light (e.g., λ₁, λ₂, λ₃, λ₄, . . . , λₙ) being transmitted along waveguide 306. This subset may include one or more of the wavelengths being transmitted through main waveguide 306. In one embodiment, waveguide 318 comprises two regions, a coupler region 313 and a tap region 315. Coupler region 313 is directly adjacent to main waveguide 306 and includes a first electrode layer (not shown) and a second electrode layer 347, which are similar to electrode layers 245 and 247, respectively (described above with reference to FIGS. 17 and 18). Application of an electrical voltage to the electrode layers permits tuning or adjustment of the index of refraction of the core layer (not shown) of waveguide 318 such that particular wavelengths of radiation may be separated from the main waveguide 306 and transmitted through waveguide 318. In one embodiment, a portion of the total intensity of a tapped wavelength is removed from waveguide 318 and directed to optical detector 316 for network management functions, such as monitoring the state of the system 300, for example. A remaining portion of the total intensity of the tapped wavelength may be transmitted through waveguide 318 to optical device 319.

In one embodiment, tap region 315 of waveguide 318 is directly adjacent to a coupler region 323 of tap waveguide 317. Coupler region 323 of tap waveguide 317 includes electrodes 321, which are also similar to the electrodes of electrode layers 245 and 247 of FIGS. 17 and 18. As will be appreciated, coupler region 323 of tap waveguide 317 functions similarly to coupler region 313 of waveguide 318, except that the index of refraction of a core layer (not shown) in coupler region 323 is tuned to separate a particular wavelength or wavelengths of radiation from waveguide 318 such that the particular wavelength of radiation may be transmitted through tap waveguide 317 to detector 316. Tap waveguide 317 may be tuned through an applied voltage, as described above. Detector 316 suitably receives the wavelength carrier signal and converts the carrier signal into a suitable electrical signal. Once tap waveguide 317 separates a particular wavelength (e.g., λ₁) from waveguide 318, waveguide 318 continues to transmit a remaining portion of radiation (e.g., λ₂ and λ₃) to another optical device 319. Optical device 319 may be any suitable optical device, including a waveguide, such as another tap waveguide for example, a fiber optic cable, a detector, a diode, and the like.

In accordance with various aspects of the invention, it will be appreciated that a demultiplexer system 300 may include a plurality of waveguides 318 and a plurality of tap waveguides 317. The lengths of the several coupler regions and/or tap regions may be configured such that, with little or no tuning, a substantially complete separation of a given number (m) of wavelengths occurs with m-1 directional couplers. Moreover, it will be appreciated that a suitable multiplexer system having a similar configuration may be fabricated in accordance with the present invention. For example, substitution of an optical emitter 116 for optical detector 316, reversal of the directional flow of radiation, and altered placement of suitable electrodes yields an integrated multiplexer system in accordance with the invention.

In accordance with another embodiment of the invention, FIG. 21 illustrates a top plan view of a demultiplexer system 400. Demultiplexer system 400 is substantially similar to demultiplexer system 200 of FIGS. 17 and 18, with the exception that optical detector system 404 further includes an electro-optical waveguide grating section 417 in alignment with a waveguide 418 and positioned between waveguide 418 and an optical detector 416. Waveguide grating section 417 may also be suitably coupled to a control circuit, such as control circuit 410, for controlling the index of refraction of the waveguide grating section 417 to provide notch filter tuning as needed. In one embodiment, waveguide grating section 417 provides a method of reducing cross-talk by filtering out unwanted wavelengths. In one embodiment, waveguide grating section 417 comprises an optical notch filter.

A cross-sectional view of the demultiplexer system 400 of FIG. 21 is illustrated in FIG. 22. Specifically, FIG. 22 illustrates a cross-sectional view of an exemplary electro-optical waveguide grating section 417 positioned between a waveguide 418 and an optical detector 416. In one embodiment, electro-optical waveguide grating section 417 comprises a core layer 450 which is positioned between a first cladding layer 452 and a second cladding layer 454. Preferably, waveguide grating section 417 is configured such that substantially all light received by a first end 456 from waveguide 418 is confined within the core layer 450 during light transmission through the waveguide grating section 417 and toward a second end 458 of waveguide grating section 417. In other words, the light is preferably transmitted through the waveguide grating section 417 with total internal reflection, as described above. In an exemplary embodiment, material selected for core layer 450 has an index of refraction n₁; material selected for first and second cladding layers 452 and 454 has an index of refraction of n₂; and n₁>n₂.

Layers 450-454 are substantially similar to layers 138-142 of FIG. 11 and may be formed of any of the materials and by any of the processes described with reference to layers 138-142. A periodic pattern is formed in core layer 450 to form an optical grating 460 within core layer 450. The periodic spacing of the optical grating 460 is such that it provides selectable transmission of the desired wavelength, as is known in the art. Optical grating 460 may be formed by etching a pattern in one of layers 450-454 through photo-assisted etching or any other suitable etching means. Optical grating 460 may also be formed by doping one of layers 450-454 with a periodic pattern of an impurity by ion implantation or other suitable means.

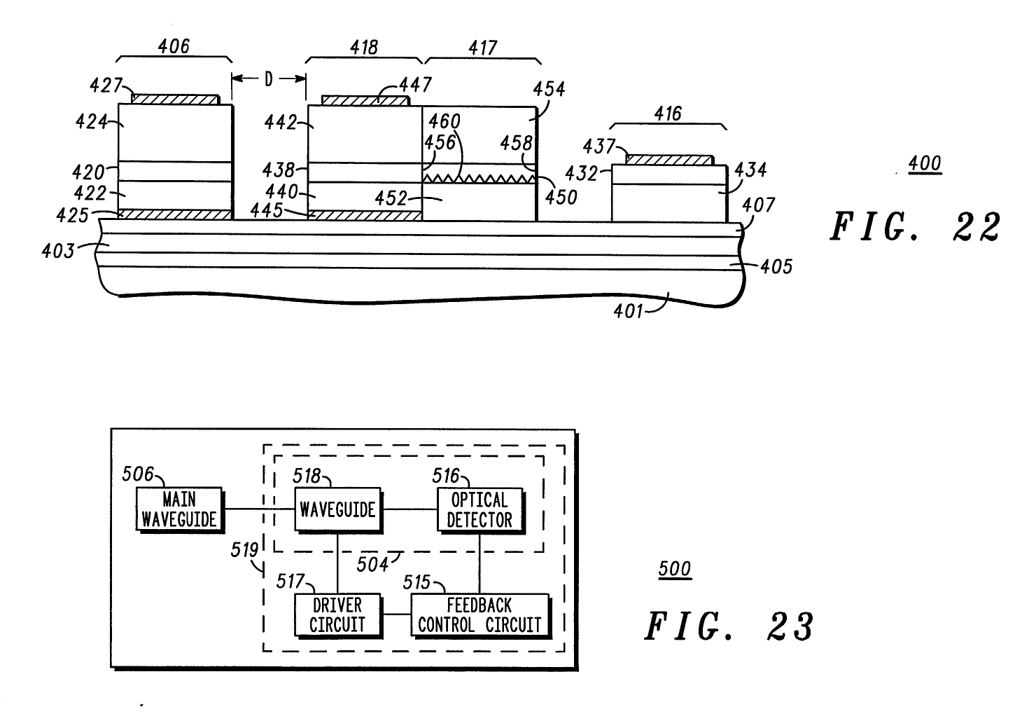

In accordance with an embodiment of the invention, FIG. 23 illustrates a top plan view of a portion of a demultiplexer system 500 which includes a feedback control loop. Exemplary demultiplexer system 500 comprises a main waveguide 506; an optical detector system 504, including an optical detector 516 and a waveguide 518; a feedback control circuit 515; and a driver circuit 517. In accordance with the present invention, each of main waveguide 506, optical detector 516, waveguide 518, feedback control circuit 517, and driver circuit 517 are monolithically integrated on a single Group IV substrate.

In general, system 500 is configured to control an output from main waveguide 506, at a desired intensity level or wavelength, using a feedback control loop 519, which includes a feedback path from optical detector 516 to main waveguide 506. In accordance with the illustrated example, optical detector 516 (with appropriate receiver circuitry) converts radiation emissions, such as light received from waveguide 518, into an electrical signal; feedback control circuit 515 manipulates the signal from optical detector 516 with an appropriate gain, and driver circuit 517 sends a signal to waveguide 518 in response to a signal received from feedback control circuit 515.

Optical detector 516 circuitry, feedback control circuit 515, and driver circuit 517 may be formed in any suitable semiconductor layer on a substrate. For example, feedback control circuit 515 and/or driver circuit 517 may be formed at least partially within the Group IV (e.g., silicon) substrate or within any semiconductor material deposited thereon.

Generally, multiplexer system 100 combines and transmits a plurality of carrier signals to an optical device, while demultiplexer systems 200-500 receive the plurality of carrier signals from an optical device and then segregates and directs each of the various, distinct carrier signals to a corresponding radiation detector that can convert a single carrier signal or wavelength into usable information or data. It will be appreciated that while a WDM system may include at least one multiplexer system 100 and at least one demultiplexer system 200-500, multiplexer system 100 and demultiplexer systems 200-500 are each separate components which may be utilized either together or individually in a variety of other types of IOC devices. In other words, multiplexer system 100 may be utilized as a component of an IOC device which does not include a demultiplexer system 200-500. Likewise, demultiplexer systems 200-500 may be utilized as a component of an IOC device which does not include multiplexer system 100. Thus, while the present invention is conveniently described herein with reference to a Wavelength Division Multiplexing system, the invention is not so limited, and the various embodiments of multiplexer system 100 and demultiplexer systems 200-500 can be employed in other suitable IOC structures and devices.

Generally, when fabricating any of the device structures of systems 100-500, a thermal hierarchy determines the order in which the various layers are deposited over the substrate. In other words, higher temperature processes are completed prior to beginning lower temperature processes. Accordingly, complementary metal oxide semiconductor (CMOS) structures, such as control circuits for example, are preferably fabricated first due to the higher temperatures required for their formation. Then, any of the various optical devices, such as radiation emitting devices, radiation detecting devices, and waveguides, may be fabricated on the substrate. Finally, the circuit metallization is deposited.

In accordance with an exemplary embodiment, fabrication of a wavelength-tunable multiplexer system 100, as described above, utilizes a monocrystalline semiconductor substrate 101, such as a silicon wafer for example, as a starting material. An accommodating buffer layer 103 is then grown epitaxially over substrate 101, and an amorphous interface layer 105 may be formed between substrate 101 and buffer layer 103 through the oxidation of substrate 101 during the growth of buffer layer 103. As indicated above, buffer layer 103 may be comprised of a monocrystalline oxide material. In addition, buffer layer 103 may comprise an amorphous oxide layer, which is formed by rapid thermal annealing of amorphous interface layer 105 and monocrystalline buffer layer 103, as described above with reference to FIG. 11.

Next, to form a radiation emitter system 104, a monocrystalline compound semiconductor layer 134 is epitaxially deposited over the template layer 107 and then patterned to form an optical emitter 116 formed at least partially in the compound semiconductor layer 134 in accordance with those methods of patterning known in the art. The waveguide 118 of the emitter system 104 may be formed by epitaxially depositing a first cladding layer 140 of material having a first index of refraction over the buffer layer 103 such that the first cladding layer 140 is adjacent to an edge of the optical emitter 116. A core layer 138 of electro-optical (EO) material having a second index of refraction is then epitaxially deposited over the first cladding layer 140. Alternatively, the core layer 138 may be formed by either ion implanting a pattern of impurity dopants to change the index of refraction of the implanted layer or selectively etching the surface of the first cladding layer 140 to form a spatial variation in the thickness of the etched layer. The ion implantation and etching may be carried out by suitable implantation and etching means known in the art. A second cladding layer 142 having a third index of refraction is then epitaxially deposited over the core layer 138.

Electrode layers may be deposited overlying the optical emitter 116 as well as underlying the first cladding layer 140 and overlying the second cladding layer 142. These electrode layers 137, 145 and 147, respectively, may be patterned to form electrode(s) for operating and electro-optically tuning the waveguide 118 and for operating the optical emitter 116, as is known in the art. Thus, a first electrode layer 145 may be deposited over the buffer layer 103, prior to depositing first cladding layer 140, and then patterned to form an electrode which underlies the waveguide 118 and which may be used in conjunction with another electrode overlying the waveguide 118 to operate and electro-optically tune the waveguide 118, as is known in the art. Integrated circuits and may also be formed partially or wholly within the substrate 101 and coupled via interconnects to the electrode(s) of electrode layers 145, 147, and 137, respectively, to electro-optically control the index of refraction of the waveguide 118 and to control the operation of the optical emitter 116.

In accordance with another exemplary embodiment, a wavelength-tunable demultiplexer system 200, as described above, may be fabricated using a similar process to that described above with reference to multiplexer system 100. Specifically, a monocrystalline semiconductor substrate 201, such as a silicon wafer for example, is utilized as a starting material, and accommodating buffer layer 203 and amorphous interface layer 205 (or a suitable amorphous oxide layer) may be formed as described above.

Next, a radiation detector system 204 is formed in a similar manner to that described above with reference to radiation emitter system 104. A monocrystalline compound semiconductor layer 234 is epitaxially deposited over the template layer 207 and then patterned to form an optical detector 216 formed at least partially in the compound semiconductor layer 234 in accordance with those methods of patterning known in the art. The waveguide 218 of the detector system 204 may be formed by epitaxially depositing a first cladding layer 240 material having a first index of refraction over the buffer layer 203 such that the first cladding layer 240 is adjacent to an edge of the optical detector 216. A core layer 238 of electro-optical (EO) material having a second index of refraction is then epitaxially deposited over the first cladding layer 240. Alternatively, the core layer 238 may be formed by either ion implanting a pattern of impurity dopants to change the index of refraction of the implanted layer or selectively etching the surface of the first cladding layer 240 to form a spatial variation in the thickness of the etched layer. The ion implantation and etching may be carried out by suitable implantation and etching means known in the art. A second cladding layer 242 having a third index of refraction is then epitaxially deposited over the core layer 238.

An electrode layer may then be deposited over the second cladding layer 242, as well as over the optical detector 216, and patterned to form electrode(s) 247 and 237, respectively, to operate and electro-optically tune the waveguide 218 and to operate the optical detector 216, as is known in the art. A first electrode layer 245 may be deposited over the buffer layer 203, prior to depositing first cladding layer 240, and then patterned to form an electrode which underlies the waveguide 218 and which may be used in conjunction with a second electrode overlying the waveguide 218 to operate and electro-optically tune the waveguide 218, as is known in the art. Integrated circuits may also be formed partially or wholly within the substrate 201 and coupled via interconnects to the electrode(s) to electro-optically control the index of refraction of the waveguide 218 and to control the operation of the optical detector 216.

The processes described above illustrate processes for forming either a wavelength-tunable multiplexer system or a wavelength-tunable demultiplexer system. Any of the above-described processes may be carried out by using MBE, CVD, MOCVD, MEE, ALE, PVD, CSD, PLD, or the like.

Clearly, the above-described embodiments of the invention are merely illustrative and are not intended to limit the scope of the present invention. A multiplicity of other combinations and embodiments of the present invention are possible, and all such combinations and embodiments fall within the ambit of the appended claims. For example, the present invention includes structures and methods for fabricating material layers which form semiconductor structures, devices, and integrated circuits including other layers, such as metal and non-metal layers. More specifically, the invention includes structures and methods for forming a compliant substrate which is used in the fabrication of semiconductor structures, devices, and integrated circuits and the material layers suitable for fabricating those structures, devices, and integrated circuits. Use of the embodiments of the present invention simplifies the integration of devices that include monocrystalline layers comprising semiconductor and compound semiconductor materials, as well as other material layers that are used to form those devices, with other components that operate more effectively or are easily and/or inexpensively formed within semiconductor or compound semiconductor materials. This permits the fabrication of smaller devices, the reduction of manufacturing costs, and the increase in yield and reliability.

In accordance with one embodiment of this invention, a monocrystalline semiconductor or compound semiconductor wafer can be used in forming monocrystalline material layers over the wafer. In this manner, the wafer is essentially a “handle” wafer which is used during the fabrication of semiconductor electrical components within a monocrystalline layer overlying the wafer. Therefore, electrical components can be formed within semiconductor materials over a wafer of at least about 200 millimeters in diameter and possibly at least about 300 millimeters in diameter. Use of this type of substrate permits a relatively inexpensive “handle” wafer to overcome the fragile nature of compound semiconductor or other monocrystalline material wafers by placing these fragile materials over a comparatively more durable and easily fabricated base material. Thus, an integrated circuit can be fabricated such that all electrical components, and particularly all active electronic devices, can be formed within or using the monocrystalline material layer, even though the substrate itself may include a monocrystalline semiconductor material. Fabrication costs for compound semiconductor devices and other devices employing non-silicon monocrystalline materials should decrease, because larger substrates can be processed more economically and more readily when compared to smaller and more fragile substrates (e.g., conventional compound semiconductor wafers).

In the foregoing specification, the invention has been described with reference to specific embodiments. However, it will be appreciated that various modifications and changes can be made without departing from the scope of the present invention as set forth in the claims below. The specification and figures are to be regarded in an illustrative manner, rather than a restrictive one, and all such modifications are intended to be included within the scope of present invention. Accordingly, the scope of the invention should be determined by the appended claims and their legal equivalents, rather than by the examples given above. For example, the steps recited in any of the method or process claims may be executed in any order and are not limited to the order presented in the claims.

Benefits, other advantages, and solutions to problems have been described above with regard to specific embodiments. However, the benefits, advantages, solutions to problems, and any element(s) that may cause any benefit, advantage, solution to occur or become more pronounced are not to be constructed as critical, required, or essential features or elements of any or all of the claims. As used, herein, the terms “comprises,” “comprising” or any other variation thereof, are intended to cover a non-exclusive inclusion, such that a process, method, article, or apparatus that comprises a list of elements does not include only those elements but may include other elements not expressly listed or inherent to such process, method, article, or apparatus.

1. A monolithically-integrated multiplexer system comprising:
a monocrystalline substrate;
a monocrystalline accommodating buffer layer overlying said substrate;
a radiation emitter system overlying said accommodating buffer layer, wherein said radiation emitter system is configured to emit radiation having a plurality of wavelengths;
a main waveguide overlying said accommodating buffer layer and positioned adjacent to said radiation emitter system, wherein said main waveguide is configured to receive and transmit radiation emitted from said radiation emitter system; and
a radiation receiver in alignment with said main waveguide, wherein said radiation receiver is configured to receive radiation emitted from said main waveguide.

2. The multiplexer system of claim 1, wherein said monocrystalline substrate comprises material selected from the group consisting of silicon, germanium, silicon carbide, indium phosphide, silicon germanium, gallium arsenide, and indium arsenide.

3. The multiplexer system of claim 1, wherein said monocrystalline substrate comprises silicon.

4. The multiplexer system of claim 1, wherein said accommodating buffer layer comprises an oxide material selected from the group consisting of alkaline-earth metal titanates, alkaline-earth metal zirconates, alkaline-earth metal hafnates, alkaline-earth metal tantalates, alkaline-earth metal ruthenates, alkaline-earth metal niobates, and metal oxides.

5. The multiplexer system of claim 1, wherein said accommodating buffer layer comprises a monocrystalline perovskite oxide material layer.

6. The multiplexer system of claim 1, wherein said accommodating buffer layer comprises a material selected from the group consisting of BaTiO₃, SrTiO₃, and SrₓBa₁₋ₓTiO₃ (where the value of x ranges from 0 to 1).

7. The multiplexer system of claim 1, further comprising an amorphous interface layer overlying said monocrystalline substrate and underlying said accommodating buffer layer.

8. The multiplexer system of claim 7, wherein said amorphous interface layer comprises silicon oxide.

9. The multiplexer system of claim 1 further comprising a template layer overlying said accommodating buffer layer and underlying said radiation receiver, said radiation emitter system, and said main waveguide.

10. The multiplexer system of claim 9, wherein said template layer comprises one of a semiconductor material and a compound semiconductor material.

11. The multiplexer system of claim 10, wherein said template layer comprises a material selected from the group consisting of Group III-V compounds, mixed Group III-V compounds, Group II-VI compounds, and mixed Group II-VI compounds.

12. The multiplexer system of claim 11, wherein said template layer comprises a material selected from the group consisting of Ti—As, SrOAs, SrGaO, and SrAlO.

13. The multiplexer system of claim 1, wherein said radiation emitter system comprises:
an optical emitter monolithically formed overlying said accommodating buffer layer and configured to emit radiation having a plurality of wavelengths; and
an electro-optical waveguide positioned adjacent to said optical emitter and configured to receive radiation emitted from said optical emitter and to transmit said radiation to said main waveguide.

14. The multiplexer system of claim 13, wherein said optical emitter comprises at least one of a laser, a light emitting diode, a fiber optic cable, and a waveguide.

15. The multiplexer system of claim 13, wherein said optical emitter comprises a monocrystalline active layer positioned between a first cladding layer and a second cladding layer.

16. The multiplexer system of claim 15, wherein said active layer comprises one of a semiconductor material and a compound semiconductor material.

17. The multiplexer system of claim 16, wherein said active layer comprises a compound semiconductor selected from the group consisting of GaAs, InP, AlGaAs, InGaAs, InGaAsP, InAlAsP, and InAlGaAs.

18. The multiplexer system of claim 15, wherein said first cladding layer and said second cladding layer comprise material independently selected from the group consisting of GaAs, GaSb, InGaAs, GaAlAs, AlGaSb, InP, InGaAsP, and InAlGaAs.

19. The multiplexer system of claim 13, wherein said waveguide comprises a directional coupler.

20. The multiplexer system of claim 13, wherein said waveguide comprises a core of electro-optically active material, either organic or inorganic, whose index of refraction is controllable by a modulating voltage.

21. The multiplexer system of claim 20, wherein said core is lattice-matched to one of said accommodating buffer layer and an underlying electrode layer.

22. The multiplexer system of claim 21, wherein said waveguide comprises a core material layer having a first refractive index and an underlying electrode layer having a second refractive index which is less than said first refractive index.

23. The multiplexer system of claim 20, wherein said waveguide comprises a core material layer having a first refractive index and a cladding material layer having a second refractive index which is less than said first refractive index.

24. The multiplexer system of claim 23, wherein said waveguide comprises material selected from the group consisting of BaTiO₃, SrₓBa₁₋ₓTiO₃ (where the value of x ranges from 0 to 1), LiNbO₃, LiTaO₃, Pb(Zr, Ti)O₃, ZnO₃, and Pb(La, Zr, Ti)O₃.

25. The multiplexer system of claim 24, wherein said core material layer comprises a dopant selected from the group consisting of titanium and protons.

26. The multiplexer system of claim 13, wherein said waveguide comprises a base layer positioned over said accommodating buffer layer, and wherein said base layer has a ridge formed therein.

27. The multiplexer system of claim 26, further comprising a cladding material layer positioned over said ridge and said base layer, wherein said cladding material layer has a first index of refraction and said base layer has a second index of refraction, and wherein said first index of refraction is less than said second index of refraction.

28. The multiplexer system of claim 1, wherein said main waveguide comprises a core of alkaline-earth metal oxide doped to have a first refractive index and a cladding layer of alkaline-earth metal oxide having a second refractive index which is less than said first refractive index.

29. The multiplexer system of claim 28, wherein said main waveguide comprises material selected from the group consisting of BaTiO₃, SrₓBa₁₋ₓTiO₃ (where the value of x ranges from 0 to 1), LiNbO₃, LiTaO₃, Pb(Zr, Ti)O₃, ZnO₃, and Pb(La, Zr, Ti)O₃.

30. The multiplexer system of claim 29, wherein said main waveguide comprises a core material layer having a first refractive index and a cladding material layer having a second refractive index which is less than said first refractive index.

31. The multiplexer system of claim 30, wherein said core material layer comprises a dopant selected from the group consisting of titanium and protons.

32. The multiplexer system of claim 1, wherein said main waveguide comprises a base layer positioned over said accommodating buffer layer, and wherein said base layer has a ridge formed therein.

33. The multiplexer system of claim 32, further comprising a cladding material layer positioned over said ridge and said base layer, wherein said cladding material layer has a first index of refraction and said base layer has a second index of refraction, and wherein said first index of refraction is less than said second index of refraction.

34. The multiplexer system of claim 1, wherein said radiation receiver is one of a fiber optic cable, a photodetector, a waveguide, and a diode.

35. The multiplexer system of claim 1, wherein said radiation receiver comprises a monocrystalline active layer overlying a monocrystalline material layer.

36. The multiplexer system of claim 35, wherein said active layer and said monocrystalline material layer each comprises one of a semiconductor material and a compound semiconductor material.

37. The multiplexer system of claim 36, wherein said active layer comprises a compound semiconductor selected from the group consisting of GaAs, InP, AlGaAs, InGaAs, InGaAsP, InAlAsP, and InAlGaAs.

38. The multiplexer system of claim 36, wherein said monocrystalline material layer comprises material selected from the group consisting of GaAs, GaSb, InGaAs, GaAlAs, AlGaSb, InP, InGaAsP, and InAlGaAs.

39. The multiplexer system of claim 13, further comprising control circuitry formed at least partially in said substrate and coupled to said optical emitter and said main waveguide.

40. A monolithically-integrated demultiplexer system comprising:
a monocrystalline substrate;
a monocrystalline accommodating buffer layer overlying said substrate;
a radiation detector system overlying said accommodating buffer layer;
a main waveguide overlying said accommodating buffer layer and positioned adjacent to said radiation detector system, wherein said main waveguide is configured to receive and transmit radiation to said radiation detector system; and
a radiation source in alignment with said main waveguide, wherein said radiation source is configured to emit radiation having a plurality of wavelengths.

41. The demultiplexer system of claim 40, wherein said monocrystalline substrate comprises material selected from the group consisting of silicon, germanium, silicon carbide, indium phosphide, silicon germanium, gallium arsenide, and indium arsenide.

42. The demultiplexer system of claim 40, wherein said monocrystalline substrate comprises silicon.

43. The demultiplexer system of claim 40, wherein said accommodating buffer layer comprises an oxide material selected from the group consisting of alkaline-earth metal titanates, alkaline-earth metal zirconates, alkaline-earth metal hafnates, alkaline-earth metal tantalates, alkaline-earth metal ruthenates, alkaline-earth metal niobates, and metal oxides.

44. The demultiplexer system of claim 40, wherein said accommodating buffer layer comprises a monocrystalline perovskite oxide material layer.

45. The demultiplexer system of claim 40, wherein said accommodating buffer layer comprises a material selected from the group consisting of BaTiO₃, SrTiO₃, and SrₓBa₁₋ₓTiO₃ (where the value of x ranges from 0 to 1).

46. The demultiplexer system of claim 40, further comprising an amorphous interface layer overlying said monocrystalline substrate and underlying said accommodating buffer layer.

47. The demultiplexer system of claim 46, wherein said amorphous interface layer comprises silicon oxide.

48. The demultiplexer system of claim 40, further comprising a template layer overlying said accommodating buffer layer and underlying said radiation receiver, said radiation emitter system, and said main waveguide.

49. The demultiplexer system of claim 48, wherein said template layer comprises one of a semiconductor material and a compound semiconductor material.

50. The demultiplexer system of claim 49, wherein said template layer comprises a material selected from the group consisting of Group III-V compounds, mixed Group III-V compounds, Group II-VI compounds, and mixed Group II-VI compounds.

51. The demultiplexer system of claim 50, wherein said template layer comprises a material selected from the group consisting of Ti—As, SrOAs, SrGaO, and SrAlO.

52. The demultiplexer system of claim 40, wherein said radiation detector system comprises:
an electro-optical waveguide monolithically formed overlying said accommodating buffer layer and configured to receive and transmit radiation emitted from said main waveguide; and
an optical detector monolithically formed overlying said accommodating buffer layer and positioned adjacent to said waveguide, wherein said optical detector is configured to receive radiation from said waveguide.

53. The demultiplexer system of claim 52, wherein said waveguide comprises a directional coupler.

54. The demultiplexer system of claim 52, wherein said waveguide comprises a core of electro-optically active material, either organic or inorganic, whose index of refraction is controllable by a modulating voltage.

55. The demultiplexer system of claim 54, wherein said core is lattice-matched to one of said accommodating buffer layer and an underlying electrode layer.

56. The demultiplexer system of claim 55, wherein said waveguide comprises a core material layer having a first refractive index and an underlying electrode layer having a second refractive index which is less than said first refractive index.

57. The demultiplexer system of claim 54, wherein said waveguide comprises a core material layer having a first refractive index and a cladding material layer having a second refractive index which is less than said first refractive index.

58. The demultiplexer system of claim 57, wherein said waveguide comprises material selected from the group consisting of BaTiO₃, SrₓBa₁₋ₓTiO₃ (where the value of x ranges from 0 to 1), LiNbO₃, LiTaO₃, Pb(Zr, Ti)O₃, ZnO₃, and Pb(La, Zr, Ti)O₃.

59. The demultiplexer system of claim 58, wherein said core material layer comprises a dopant selected from the group consisting of titanium and protons.

60. The demultiplexer system of claim 52, wherein said waveguide comprises a base layer positioned over said accommodating buffer layer, and wherein said base layer has a ridge formed therein.

61. The demultiplexer system of claim 60, further comprising a cladding material layer positioned over said ridge and said base layer, wherein said cladding material layer has a first index of refraction and said base layer has a second index of refraction, and wherein said first index of refraction is less than said second index of refraction.

62. The demultiplexer system of claim 52, wherein said optical detector is one of a fiber optic cable coupled to a detector and a waveguide coupled to a photodetector, a waveguide.

63. The demultiplexer system of claim 52, wherein said optical detector comprises a monocrystalline active layer overlying a monocrystalline material layer.

64. The demultiplexer system of claim 63, wherein said active layer and said monocrystalline material layer each comprises one of a semiconductor material and a compound semiconductor material.

65. The demultiplexer system of claim 64, wherein said active layer comprises a compound semiconductor selected from the group consisting of GaAs, InP, AlGaAs, InGaAs, InGaAsP, InAlAsP, and InAlGaAs.

66. The demultiplexer system of claim 64, wherein said monocrystalline material layer comprises material selected from the group consisting of GaAs, GaSb, InGaAs, GaAlAs, AlGaSb, InP, InGaAsP, and InAlGaAs.

67. The demultiplexer system of claim 40, wherein said main waveguide comprises a core of alkaline-earth metal oxide doped to have a first refractive index and a cladding layer of alkaline-earth metal oxide having a second refractive index which is less than said first refractive index.

68. The demultiplexer system of claim 67, wherein said main waveguide comprises material selected from the group consisting of BaTiO₃, SrₓBa₁₋ₓTiO₃ (where the value of x ranges from 0 to 1), LiNbO₃, LiTaO₃, Pb(Zr, Ti)O₃, ZnO₃, and Pb(La, Zr, Ti)O₃.

69. The demultiplexer system of claim 68, wherein said main waveguide comprises a core material layer having a first refractive index and a cladding material layer having a second refractive index which is less than said first refractive index.

70. The demultiplexer system of claim 69, wherein said core material layer comprises a dopant selected from the group consisting of titanium and protons.

71. The demultiplexer system of claim 40, wherein said main waveguide comprises a base layer positioned over said accommodating buffer layer, wherein said base layer has a ridge formed therein.

72. The demultiplexer system of claim 71, further comprising a cladding material layer positioned over said ridge and said base layer, wherein said cladding material layer has a first index of refraction and said base layer has a second index of refraction, and wherein said first index of refraction is less than said second index of refraction.

73. The demultiplexer system of claim 40, wherein said radiation source comprises at least one of a laser, a light emitting diode, a fiber optic cable coupled to an optical source, and a waveguide coupled to the optical source.

74. The demultiplexer system of claim 40, wherein said radiation source comprises a monocrystalline active layer positioned between a first cladding layer and a second cladding layer.

75. The demultiplexer system of claim 74, wherein said active layer comprises one of a semiconductor material and a compound semiconductor material.

76. The demultiplexer system of claim 75, wherein said active layer comprises a compound semiconductor selected from the group consisting of GaAs, InP, AlGaAs, InGaAs, InGaAsP, InAlAsP, and InAlGaAs.

77. The demultiplexer system of claim 74, wherein said first cladding layer and said second cladding layer comprise material independently selected from the group consisting of GaAs, GaSb, InGaAs, GaAlAs, AlGaSb, InP, InGaAsP, and InAlGaAs.

78. The demultiplexer system of claim 52, wherein said radiation detector system further comprises an electro-optical waveguide grating section in alignment with said waveguide and positioned between said waveguide and said optical detector.

79. The demultiplexer system of claim 78, wherein said waveguide grating section comprises a core layer positioned between a first cladding layer and a second cladding layer, and wherein said core layer comprises an optical grating formed within said core layer.

80. The demultiplexer system of claim 52, further comprising control circuitry formed in said substrate and coupled to said optical detector and electro-optical waveguide.

81. The demultiplexer system of claim 80, further configured to control an output from said main waveguide using a feedback control loop which includes a feedback path from said optical detector to said electro-optical waveguide.

82. The demultiplexer system of claim 52, further comprising at least one tap waveguide in alignment with an optical detector and adjacent to said waveguide.

83. The demultiplexer system of claim 82, wherein said waveguide and said at least one tap waveguide are configured to separate radiation transmitted by said waveguide into a plurality of radiation streams, wherein each radiation stream is characterized by substantially a single wavelength.

84. The demultiplexer system of claim 40 comprising a plurality of radiation detector systems, wherein each radiation detector system is configured to separate radiation transmitted by said main waveguide into a plurality of radiation streams.

85. The demultiplexer system of claim 84, wherein each radiation detector system further comprises:
an electro-optical waveguide monolithically formed overlying said accommodating buffer layer and configured to receive and transmit radiation emitted from said main waveguide;
a plurality of tap waveguides monolithically formed overlying said accommodating buffer layer and configured to receive and transmit radiation emitted from said waveguide;
an optical detector monolithically formed overlying said accommodating buffer layer and positioned adjacent to said tap waveguide, wherein said optical detector is configured to receive radiation from said tap waveguide;
an optical device monolithically formed overlying said accommodating buffer layer and positioned adjacent to said waveguide, wherein said optical device is configured to receive radiation from said waveguide; and
wherein said waveguide and said plurality of tap waveguides are configured to separate radiation transmitted by said waveguide into a plurality of radiation streams, each radiation stream being characterized by substantially a single wavelength.

86. A process for fabricating a multiplexer system, the process comprising the steps of:
providing a monocrystalline substrate;
epitaxially growing an accommodating buffer layer over at least one of said substrate and an amorphous interface layer;
epitaxially growing a template layer over said accommodating buffer layer;
forming a radiation emitter system overlying said template layer;
forming a main waveguide overlying at least one of said accommodating buffer layer and said template layer; and
forming a radiation receiver overlying said template layer.

87. The process of claim 86, wherein growing an accommodating buffer layer comprises epitaxially growing an oxide material selected from the group consisting of alkaline-earth metal titanates, alkaline-earth metal zirconates, alkaline-earth metal hafnates, alkaline-earth metal tantalates, alkaline-earth metal ruthenates, alkaline-earth metal niobates, and metal oxides.

88. The process of claim 86, wherein growing an accommodating buffer layer comprises epitaxially growing a layer of material selected from the group consisting of BaTiO₃, SrTiO₃, and SrₓBa₁₋ₓTiO₃ (where the value of x ranges from 0 to 1).

89. The process of claim 86, wherein growing a template layer comprises epitaxially growing a layer on one or a semiconductor material and a compound semiconductor material.

90. The process of claim 89, wherein growing a template layer comprises epitaxially growing a layer of material selected from the group consisting of Group III-V compounds, mixed Group III-V compounds, Group II-VI compounds, and mixed Group II-VI compounds.

91. The process of claim 86, wherein forming a radiation emitter system further comprises:
forming an optical emitter overlying said template layer; and
forming an electro-optical waveguide overlying said template layer.

92. The process of claim 91, wherein forming an optical emitter further comprises:
epitaxially growing a first cladding layer overlying said template layer;
epitaxially growing a monocrystalline active layer over said first cladding layer; and
epitaxially growing a second cladding layer over said monocrystalline active layer.

93. The process of claim 92, further comprising epitaxially growing an electrode layer overlying said second cladding layer.

94. The process of claim 91, wherein forming an electro-optical waveguide further comprises:
epitaxially growing a first cladding layer overlying said accommodating buffer layer;
epitaxially growing a monocrystalline core material layer over said first cladding layer; and
epitaxially growing a second cladding layer over said monocrystalline core material layer.

95. The process of claim 94, further comprising:
epitaxially growing a first electrode layer underlying said first cladding layer; and
forming a second electrode layer overlying said second cladding layer.

96. The process of claim 91, wherein forming an electro-optical waveguide further comprises:
epitaxially growing a cladding material layer overlying said accommodating buffer layer; and
ion implanting a dopant in said cladding material layer.

97. The process of claim 96, further comprising:
epitaxially growing a first electrode layer underlying said cladding material layer; and
forming a second electrode layer overlying said cladding material layer.

98. The process of claim 91, wherein forming an electro-optical waveguide further comprises:
epitaxially growing a first cladding layer overlying said accommodating buffer layer;
selectively etching a surface of said first cladding material layer;
epitaxially growing a monocrystalline core material layer over said first cladding layer; and
epitaxially growing a second cladding layer overlying said core material layer.

99. The process of claim 98, further comprising:
epitaxially growing a first electrode layer underlying said first cladding layer; and
forming a second electrode layer overlying said second cladding layer.

100. The process of claim 91, wherein forming an electro-optical waveguide further comprises:
epitaxially growing a base layer overlying said accommodating buffer layer; and
selectively etching a surface of said base layer to form a spatial variation in a thickness of said base layer and thereby form a ridge above said base layer.

101. The process of claim 100, further comprising:
epitaxially growing a first electrode layer underlying said base layer; and
forming a second electrode layer overlying said ridge of said base layer.

102. The process of claim 100, further comprising:
epitaxially growing an electrode layer over said base layer and adjacent to said ridge.

103. The process of claim 100, further comprising epitaxially depositing a cladding material layer over said ridge and said base layer.

104. The process of claim 86, wherein forming a main waveguide further comprises:
epitaxially growing a first cladding layer overlying at least one of said accommodating buffer layer and said template layer;
epitaxially growing a monocrystalline core material layer over said first cladding layer; and
epitaxially growing a second cladding layer over said monocrystalline core material layer.

105. The process of claim 104, further comprising:
epitaxially growing a first electrode layer underlying said first cladding layer; and
forming a second electrode layer overlying said second cladding layer.

106. The process of claim 86, wherein forming a main waveguide further comprises:
epitaxially growing a base layer overlying said accommodating buffer layer; and
selectively etching a surface of said base layer to form a spatial variation in a thickness of said base layer and thereby form a ridge above said base layer.

107. The process of claim 106, further comprising:
epitaxially growing a first electrode layer underlying said base layer; and
forming a second electrode layer overlying said ridge of said base layer.

108. The process of claim 106, further comprising:
epitaxially growing an electrode layer over said base layer and adjacent to said ridge.

109. The process of claim 106, further comprising epitaxially depositing a cladding material layer over said ridge and said base layer.

110. The process of claim 86, wherein forming a radiation receiver further comprises:
epitaxially growing a monocrystalline semiconductor or compound semiconductor material layer over said template layer; and
epitaxially growing an active layer over said monocrystalline semiconductor or compound semiconductor material layer.

111. The process of claim 98, further comprising forming an electrode layer overlying said active layer.

112. The process of claim 86, further comprising forming at least one control circuit at least partially in said monocrystalline substrate.

113. A process for fabricating a demultiplexer system, the process comprising the steps of:
providing a monocrystalline substrate;
epitaxially growing an accommodating buffer layer over at least one of said substrate and an amorphous interface layer;
epitaxially growing a template layer over said accommodating buffer layer;
forming a radiation detector system overlying said template layer;
forming a main waveguide overlying said accommodating buffer layer; and
forming a structure for coupling a radiation source with the main waveguide.

114. The process of claim 113, wherein growing an accommodating buffer layer comprises epitaxially growing an oxide material selected from the group consisting of alkaline-earth metal titanates, alkaline-earth metal zirconates, alkaline-earth metal hafnates, alkaline-earth metal tantalates, alkaline-earth metal ruthenates, alkaline-earth metal niobates, and metal oxides.

115. The process of claim 113, wherein growing an accommodating buffer layer comprises epitaxially growing a layer of material selected from the group consisting of BaTiO₃, SrTiO₃, and SrₓBa₁₋ₓTiO₃ (where the value of x ranges from 0 to 1).

116. The process of claim 113, wherein growing a template layer comprises epitaxially growing a layer of one of a semiconductor material and a compound semiconductor material.

117. The process of claim 116, wherein growing a template layer comprises epitaxially growing a layer of material selected from the group consisting of Group III-V compounds, mixed Group III-V compounds, Group II-VI compounds, and mixed Group II-VI compounds.

118. The process of claim 113, wherein forming a radiation detector system further comprises:
forming an optical detector overlying said template layer; and
forming an electro-optical waveguide overlying said template layer.

119. The process of claim 118, wherein forming an optical detector further comprises:
epitaxially growing a monocrystalline semiconductor or compound semiconductor material layer over said template layer; and
epitaxially growing an active layer over said monocrystalline semiconductor or compound semiconductor material layer.

120. The process of claim 119, further comprising forming an electrode layer overlying said active layer.

121. The process of claim 118, wherein forming an electro-optical waveguide further comprises:
epitaxially growing a first cladding layer overlying said accommodating buffer layer;
epitaxially growing a monocrystalline core material layer over said first cladding layer; and
epitaxially growing a second cladding layer over said monocrystalline core material layer.

122. The process of claim 121, further comprising:
epitaxially growing a first electrode layer underlying said first cladding layer; and
forming a second electrode layer overlying said second cladding layer.

123. The process of claim 118, wherein forming an electro-optical waveguide further comprises:
epitaxially growing a cladding material layer overlying said accommodating buffer layer; and
ion implanting a dopant in said cladding material layer.

124. The process of claim 123, further comprising:
epitaxially growing a first electrode layer underlying said cladding material layer; and
forming a second electrode layer overlying said cladding material layer.

125. The process of claim 118, wherein forming an electro-optical waveguide further comprises:
epitaxially growing a first cladding layer overlying said accommodating buffer layer;
selectively etching a surface of said first cladding material layer;
epitaxially growing a monocrystalline core material layer over said first cladding layer; and
epitaxially growing a second cladding layer overlying said core material layer.

126. The process of claim 125, further comprising:
epitaxially growing a first electrode layer underlying said first cladding layer; and
forming a second electrode layer overlying said second cladding layer.

127. The process of claim 118, wherein forming an electro-optical waveguide further comprises:
epitaxially growing a base layer overlying said accommodating buffer layer; and
selectively etching a surface of said base layer to form a spatial variation in a thickness of said base layer and thereby form a ridge above said base layer.

128. The process of claim 127, further comprising:
epitaxially growing a first electrode layer underlying said base layer; and
forming a second electrode layer overlying said ridge of said base layer.

129. The process of claim 127, further comprising:
forming an electrode layer over said base layer and adjacent to said ridge.

130. The process of claim 127, further comprising epitaxially depositing a cladding material layer over said ridge and said base layer.

131. The process of claim 118, further comprising forming an electro-optical waveguide grating section overlying said accommodating buffer layer.

132. The process of claim 131, wherein forming an electro-optical waveguide grating section further comprises:
epitaxially growing a first cladding layer overlying said accommodating buffer layer;
epitaxially growing a monocrystalline core material layer over said first cladding layer;
patterning said monocrystalline material layer to form an optical grating within said monocrystalline core material layer; and
epitaxially growing a second cladding layer over said monocrystalline core material layer.

133. The process of claim 113, wherein forming a main waveguide further comprises:
epitaxially growing a first cladding layer overlying at least one of said accommodating buffer layer and said template layer;
epitaxially growing a monocrystalline core material layer over said first cladding layer; and
epitaxially growing a second cladding layer over said monocrystalline core material layer.

134. The process of claim 133, further comprising:
epitaxially growing a first electrode layer underlying said first cladding layer; and
forming a second electrode layer overlying said second cladding layer.

135. The process of claim 113, wherein forming a main waveguide further comprises:
epitaxially growing a base layer overlying said accommodating buffer layer; and
selectively etching a surface of said base layer to form a spatial variation in a thickness of said base layer and thereby form a ridge above said base layer.

136. The process of claim 135, further comprising:
epitaxially growing a first electrode layer underlying said base layer; and
forming a second electrode layer overlying said ridge of said base layer.

137. The process of claim 135, further comprising:
forming an electrode layer over said base layer and adjacent to said ridge.

138. The process of claim 135, further comprising epitaxially depositing a cladding material layer over said ridge and said base layer.

139. The process of claim 113, wherein forming a radiation source further comprises:
epitaxially growing a first cladding layer overlying said template layer;
epitaxially growing a monocrystalline active layer over said first cladding layer; and
epitaxially growing a second cladding layer over said monocrystalline active layer.

140. The process of claim 139, further comprising forming an electrode layer overlying said second cladding layer.

141. The process of claim 113, further comprising forming a tap waveguide overlying said accommodating buffer layer.

142. The process of claim 141, wherein forming a tap waveguide further comprises:
epitaxially growing a first cladding layer overlying said accommodating buffer layer;
epitaxially growing a monocrystalline core material layer over said first cladding layer; and
epitaxially growing a second cladding layer over said monocrystalline core material layer.

143. The process of claim 142, further comprising:
epitaxially growing a first electrode layer underlying said first cladding layer; and
forming a second electrode layer overlying said second cladding layer.

144. The process of claim 141, wherein forming a tap waveguide further comprises:
epitaxially growing a cladding material layer overlying said accommodating buffer layer; and
ion implanting a dopant in said cladding material layer.

145. The process of claim 144, further comprising:
epitaxially growing a first electrode layer underlying said cladding material layer; and
forming a second electrode layer overlying said cladding material layer.

146. The process of claim 141, wherein forming a tap waveguide further comprises:
epitaxially growing a first cladding layer overlying said accommodating buffer layer;
selectively etching a surface of said first cladding material layer;
epitaxially growing a monocrystalline core material layer over said first cladding layer; and
epitaxially growing a second cladding layer overlying said core material layer.

147. The process of claim 146, further comprising:
epitaxially growing a first electrode layer underlying said first cladding layer; and
forming a second electrode layer overlying said second cladding layer.

148. The process of claim 141, further comprising separating radiation transmitted by said electro-optical waveguide into a plurality of radiation streams, wherein each radiation stream is characterized by substantially a single wavelength.

149. The process of claim 113, further comprising forming at least one control circuit at least partially in said monocrystalline substrate.

150. A process for fabricating an integrated optical device structure, the process comprising the steps of:
providing a monocrystalline substrate;
epitaxially growing an accommodating buffer layer over at least one of said substrate and an amorphous interface layer;
epitaxially growing a template layer over said accommodating buffer layer;
forming at least two waveguide structures overlying at least one of said accommodating buffer layer and said template layer; and
forming at least one of an optical emitter and an optical detector overlying said template layer, wherein said at least one of an optical emitter and an optical detector optically communicates with one of said at least two waveguide structures.
